(19) United States
(12) Patent Application Publication
(10) Pub. No.: US 2005/0074022 A1
(43) Pub. Date: Apr. 7, 2005

(54) Data transmitting apparatus and data receiving apparatus

(76) Inventors: Naoe Kato, Toyota-shi (JP); Yusuke Mizuno, Kasugai-shi (JP); Keishi Sugimoto, Okazaki-shi (JP); Kohji Okuno, Osaka-shi (JP); Kiyoshi Owada, Hirakata-shi (JP)

Correspondence Address: SNELL & WILMER LLP, 1920 MAIN STREET, SUITE 1200, IRVINE, CA, 92614-7230, US

(21) Appl. No.: 10/415,387

(22) PCT Filed: Nov. 1, 2001
(86) PCT No.: PCT/JP01/09597

(30) Foreign Application Priority Data
Nov. 1, 2000 (JP) 2000-334290
Nov. 7, 2000 (JP) 2000-338640

(51) Int. Cl. H04J 3/26

(52) U.S. Cl. 370/432; 370/487

(57) ABSTRACT

A data transmitting apparatus for transmitting data to a plurality of data receiving apparatuses comprises acquiring means, organizing means, and transmitting means. The acquiring means acquires a plurality of sets of selection data, each set of which is targeted for one data receiving apparatus model. The organizing means compares the plurality of sets of selection data and extracts common data and unique data. The common data is a portion of one set of selection data that is also contained in one or more other sets of selection data, and the unique data is a remaining portion in each set of selection data left after excluding the common data. The transmitting means transmits the common data and the unique data together to the plurality of data receiving apparatuses.

### TECHNICAL FIELD

The present invention relates to a data transmitting apparatus and a data receiving apparatus. More particularly, the present invention relates to a technique of transmitting/receiving control programs for a plurality of models of data receiving apparatuses.

### BACKGROUND ART

In these days, the digital broadcasting using MPEG (Moving Picture Coding Experts Group) transport streams (hereinafter, referred to as “TSs”) has been offering broadcasting of image data, voice data, and various other types of data.

FIG. 46 is a schematic block diagram showing a MPEG2-compliant digital broadcast transmitter.

This broadcast transmitter comprises a plurality of encoders 201, a data generating circuit 202, a multiplexing circuit 203, and a modulator 204. Each encoder 201 digitizes image data and voice data one by one for each broadcast program, and then encodes and compresses the digitized data to generate an image stream and a voice stream. The data generating circuit 202 generates data streams from PSI (Program Specific Information), SI (Service Information), and other information. The multiplexing circuit 203 carries out time-division multiplexing of the data streams together with the image streams and voice streams of a plurality of broadcast programs, and assembles the multiplexed data into TS packets. The modulator 204 carries out digital modulation of the TS packets to generate a modulated wave that is transmittable.

Image streams and voice streams generated by the plurality of encoders 201 and data streams generated by data generating circuit 202 are time-division multiplexed by the multiplexing circuit 203 to generate multiplexed TS packets in compliance with MPEG2. Then, the modulator 204 digitally modulates theses TS packets into a modulated wave.

In this description, there are shown three sets of units for generating modulated waves in the above manner. Each modulator 204 generates modulated waves in different frequencies from the others, and sends out to communication paths (radio waves, cables and the like). In the case of digital broadcasting, for example, it is possible to simultaneously transmit as many different modulated waves as the number of transponders (repeaters) that a satellite (not illustrated) is equipped with. Each modulated wave is simultaneously transmitted to a plurality of digital broadcast receivers via a transponder that corresponds to each modulator 204.

FIG. 47 is a schematic block diagram showing a MPEG-2 compliant digital broadcast receiver.

This receiver comprises a tuner 301, a demodulator 302, and a descrambler 303, a transport decoder (hereinafter referred to as a “TD”) 304, a voice decoder 305, an image decoder 306, a CPU (Central Processing Unit) 307, a flash ROM (Read Only Memory) 308, and a main RAM (Random Access Memory) 309, an image synthesizer 310, and a CPU bus 311. The tuner 301 receives the modulated wave that is on the user-requested channel by tuning selectively from among a plurality of modulated waves sent out on the transmitted channel. The demodulator 302 carries out digital demodulation of the received waves. The descrambler 303 performs descramble of the scrambled TS packets. The TS 304 extracts streams of interest from the multiplexed TS packets. The voice decoder 305 decompresses and composites the voice stream, followed by analog conversion to generate voice signals. The image decoder 306 decompresses and composites the image stream to generate image information. The CPU 307 controls each component constituting this receiver. The flash ROM 308 stores a control program for the CPU 307, and common data. The main RAM 309 is a work area for the CPU 307. The image synthesizer 310 synthesizes the image information and the service information to generate image signals. The CPU bus 311 connects all the components so as to allow data transmission among them.

Here, the CPU bus 311 is connected to the tuner 301, the demodulator 302, the TD 304, the CPU 307, the flash ROM 308, the main RAM 309, and to the image synthesizer 310, and used upon control by CPU 307 or data transmission in response to DMA (Direct Memory Access) or the like.

Also shown in FIG. 47, along with the receiver, are a speaker 312 for converting the voice signals generated by the voice decoder 310 into voice, and the monitor 313 for generating images from the image signals generated by the image synthesizer 313.

The modulated wave received by the tuner 301 is demodulated by the demodulator 302 to generate multiplexed TSs, and streams of interest are extracted by the TD 304. At this point, the extracted voice stream is converted to voice signals by the voice decoder 305, the resulting voice signals are then converted to voice by the speaker 312. The extracted image stream is converted to image information by the image decoder 306 and then synthesized with service information by the image synthesizer 310, so that the resulting image is displayed on the monitor 313.

There are cases where changes must be made in the control program and control data, such as LOGO and font, for digital broadcast receiver due to changes in services of the broadcasting station, the data structure, or the like. There are various ways to rewire control programs and control data in use. One way is a following technique called program download, which is performed relatively easily: a broadcasting station transmits a new control program or new control data (hereinafter, the new control program, the new control data, and the like transmitted here are referred to as “download data”), and digital broadcast receivers receive the download data and rewires the control program and the control data, which have been in use up to that point, with the newly received download data.

FIG. 48 is a view showing a pattern of download data transmission in digital broadcasting. Download data is transmitted along with image data, voice data, and the like, from a broadcasting station to a user's household via a satellite.

It should be noted here that there are many models of digital broadcast receivers are out on the market from a plurality of makers. Generally, each model has a different control program, and therefore, the digital broadcast transmitter is required to transmit as many sets of download data as the number of models.

There are two techniques to transmit a plurality of sets of download data. One is multi-stream transmission to send a plurality of streams, each derived from one set of download data, simultaneously in parallel. The other is single-stream transmission to send a single stream for each set of download data one by one in a predetermined time period.

FIG. 49A is a schematic view showing multi-stream transmission and FIG. 49B is a schematic view showing single-stream transmission.

In the multi-stream transmission technique, download data for any model of receiver is available at all times, but it takes time to complete download.

In the single-stream transmission technique, on the other hand, download is completed within a shorter time compared to the multi-stream transmission when a download data stream for that particular receiver itself is being transmitted. However, download is not possible while download data streams for other models are being transmitted, and the receiver has to wait until a download data stream for that particular receiver is transmitted.

The cycle for introducing new products on the market tends to be shorter and shorter, and each maker is releasing new products one after another. Naturally, the number of models, which require different download data, will increase more and more.

Generally speaking, the bandwidth available for broadcasters is limited. To transmit a large amount of different download data within the limited bandwidth, the above-described multi-stream transmission is not desirable in that time taken to complete download is becoming increasingly longer, and the above-described singly-stream transmission is not desirable either in that a download stream for one receiver model is transmitted in a smaller proportion to the entire transmission period.

Further, according to the standards set by ARIB (Association of Radio Industries and Businesses), more than two versions of DLTs (DownLoad Table) can not be transmitted simultaneously if they have the same maker ID and model ID. Consequently, in order to make two visions of download data, such as a bug-patched version and a function upgraded version, selectively available at a receiving end, each set of download data needs to be transmitted in a different time period, which is inconvenient.

It is, therefore, an object of the present invention is to provide a data transmitting apparatus, typified by a digital broadcast transmitter, that effectively transmits/receives a plurality of control programs within a limited bandwidth, a data receiving apparatus, typified by a digital broadcast receiver, a method of data transmission, a method for data reception, a computer readable medium storing a data transmission program, and a computer readable medium storing a data reception program.

### DISCLOSURE OF THE INVENTION

According to the present invention, a data transmitting apparatus for transmitting data to a plurality of data receiving apparatuses comprises acquiring means, organizing means, and transmitting means. The acquiring means acquires a plurality of sets of selection data, each set of which is targeted for one data receiving apparatus model. The organizing means compares the plurality of sets of selection data and extracts common data and unique data. 5 The common data is a portion of one set of selection data that is also contained in one or more other sets of selection data and the unique data is a remaining portion in each set of selection data left after excluding the common data. The transmitting means transmits the common data and the unique data together to the plurality of data receiving apparatuses.

With this construction, common data is extracted and transmitted without repeatedly transmitting the same data, so that the total amount of data to be transmitted is decreased.

Therefore, data is effectively transmitted within a limited bandwidth.

Further, in the data transmitting apparatus according to the present invention, each set of selection data may be composed of a plurality of modules and the organizing means may include common data extracting means, unique data extracting means, recording means, and encrypting means. The common data extracting means extracts, as the common data, a module of which substance is common among all the sets of selection data by comparing the plurality of sets of selection data module by module. The unique data extracting means extracts, as the unique data, all the modules other than the modules extracted by the common data extracting means. The recording means records, in advance, an encryption key that corresponds to each of the modules extracted as the unique data by the unique data extracting means. The encrypting means encrypts each of the modules extracted as the unique data using the corresponding encryption key recorded in the recording means. The transmitting means may transmit the modules extracted as the common data by the common data extracting means and the modules encrypted by the encrypting means together to the plurality of data receiving apparatuses.

With this construction, each module extracted as common data is encrypted with a corresponding encryption key and then transmitted. Thus, the encrypted modules are decryptable and available only to a data receiving apparatus having a corresponding decryption key.

Alternatively, in the data transmitting apparatus according to the present invention, the organizing means may (1) extract, as the common data, a portion of selection data that is common among two or more sets of selection data, (2) append, to each piece of the extracted common data, all pieces of identification information relating to sets of the selection data which the piece of the common data has been extracted, and (3) append, to each piece of the extracted unique data, one piece of identification information relating to one set of the selection data from which the piece of the unique data has been extracted. The transmitting means may transmit together: each piece of the common data together with all the pieces of identification information appended thereto; and each piece of the unique data together with the one piece of identification information appended thereto.

With this construction, one piece of common data is transmitted together with identification information identifying a plurality of target data receiving apparatus models. Thus, the same data is suitably received and used by the plurality of data receiving apparatus models.

Further, in the data transmitting apparatus according to the present invention, each set of the selection data may be (1) a set of data targeted for a different data receiving apparatus model, (2) a set data targeted for the same data receiving apparatus model but in a different version, or (3) a set of data targeted for a different data receiving apparatus model and in a different version, and may include at least a control program used by a target data receiving apparatus model. The organizing means may detect the common data by comparing the plurality of sets of selection data. Here, the comparison may be conducted by model, by version, or by both model and version.

With this construction, a plurality of sets of selection data are compared model by model, version by version, version by version among different models, so that common data is detected.

Further, in the data transmitting apparatus according to the present invention, the organizing means may include common data extracting means, unique data extracting means, and identification information appending means. The common data extracting means extracts the common data. The unique data extracting means excludes the common data from each set of the selection data thereby to extract the unique data that is unique to each set of the selection data. The identification information appending means appends, to each piece of the common data, all the pieces of identification information relating to all the sets of the selection data from which the piece of the common data has been extracted. The identification information appending means also appends, to each piece of the unique data, the one piece of identification information relating to the set of the selection data from which the piece of the unique data has been extracted.

With this construction, common data and unique data are extracted. Then, each piece of common data is appended with a plurality of pieces of identification information each identifying a target data receiving apparatus model while each piece of unique data is appended with one piece of identification information identifying one target data receiving apparatus model.

Further, in the data transmitting apparatus according to the present invention, each set of the selection data may be composed of a plurality of modules each having a different attribute. The common data extracting means may extract, as the common data, a module of which substance is common among a plurality of sets of the selection data by comparing modules having the same attribute in different sets of the selection data. The unique data extracting means may extract, as the unique data, all the modules other than the modules extracted by the common data extracting means.

With this construction, common data and unique data are extracted on a module-by-module basis, so that extraction is performed relatively easily.

Alternatively, in the data transmitting apparatus according to the present invention, each set of the selection data may be composed of a plurality of modules each having a different attribute. The organizing means may include module recording means, judging means, module and registering means. The module recording means is provided with a storage area for recording modules together with identification information appended to the modules. The judging means judges whether each of the modules has the same attribute and the substance as any of the modules recorded in the module recording means. The module registering means registers the plurality of modules one by one in the module recording means. As a result, (1) when the judging means judges that there is no module recorded in the module recording means having the same attribute and the substance as a current module, the current module is appended with a piece of identification information about a corresponding set of the selection data and then recorded in the module recording means, and (1) when the judging means judges that there is a module recorded in the module recording means having the same attribute and the substance as a current module, the module recorded in the module recording means is additionally appended a piece of identification information relating to a set of the selection data corresponding to the current module. The transmitting means may transmit all the modules recorded in the module recording means after the plurality of modules are all registered.

With this construction, common modules and unique modules are extracted by recording modules one by one, so that processing is simplified.

Further, in the data transmitting apparatus according to-the present invention, the transmitting means may include transmission sequence determining means for determining a sequence of modules. As a result, modules having the same attribute in different sets of the selection data are transmitted consecutively.

With this construction, modules having the same attribute are transmitted consecutively, which results in that modules of the same model or version are not likely transmitted consecutively.

As a result, a data receiving apparatus overwrites a module while receiving a module that is unnecessary to that data receiving apparatus, whereby data is updated effectively even if the data receiving apparatus is incapable of performing temporarily storage of a module and overwriting of a module at the same time in parallel. In addition, a RAM used to temporarily store modules may be smaller in capacity.

Further, in the data transmitting apparatus according to the present invention, each of the modules constituting each set of the selection data may be appended with charge information that indicates whether a charge is to be made for the module. The organizing means may further include charge information appending means. The charge information appending means appends, to each module or to each piece of identification information at the time of appending identification information, charge information that is appended to an original module.

With this construction, chargeable data is processed. In addition, charge information is appended to each module or to each piece of identification information, so that charge conditions are set in detail.

Further, in the data transmitting apparatus according to the present invention, the organizing means may further include recording means, detecting means, and replacing means. The recording means records, in advance, a previous version of each set of the selection data. The detecting means compares each set of the selection data acquired by the acquiring means with a corresponding set of selection data in a previous version recorded in the recording means on a module-by-module basis so as to detect a module of which substance is common among the two sets of selection data. The replacing means for replacing the substance of the module detected by the detecting means with an instruction command that instructs the plurality of data receiving apparatuses to use the module in the previous version.

With this replacing means construction, a module having the same substance as the previous version is not transmitted, so that the total amount of data transmitted is decreased. In addition, when any of the modules is replaced with an instruction command, it is impossible for a data receiving apparatus without the previous version stored therein to have complete set of selection data. Therefore, a new set of selection data is protected from unauthorized use by a malicious data receiving apparatus.

Further, in the data transmitting apparatus according to the present invention, the organizing means may further include information data appending means for appending, to each of the modules, information data that provides an explanation of the module.

With this construction, information data is appended to each module.

Alternatively, in the data transmitting apparatus according to the present invention, the organizing means may further include information data appending means for appending information data relating to each corresponding set of the selection data to each piece of the unique data extracted by the unique data extracting means.

With this construction, information data is appended to each piece of common data.

In another aspect, the present invention provides a data receiving apparatus for receiving and storing a set of control program data targeted for the data receiving apparatus selectively from among a plurality of sets of control program data transmitted from a data transmitting apparatus to a plurality of data receiving apparatuses, wherein: each set of the control program data has been divided into a plurality of modules and transmitted sequentially; the plurality of modules includes one or more unique modules that are the modules other than the modules being common among all the control program data; and each of the unique modules is appended with a piece of module information that is used to determine whether the module is executable and is to be stored by each data receiving apparatus. The data receiving apparatus according to the present invention comprises recording means, obtaining means, determining means, and storing means. The recording means records, in advance, specific information for specifying a unique module that is executable and is to be stored by the data receiving apparatus. The obtaining means obtains module information appended to each of the unique modules. The determining means determines whether each of the unique modules is executable and is to be stored by the data receiving apparatus with reference to the module information and the specific information. The storing means, when the determining means determines that each of the modules is executable and is to be stored by the data receiving apparatus, receives the module and for storing the module being executable in a predetermined device.

With this construction, it is determined whether a module is executable and is to be stored by the data receiving apparatus itself with reference to the module information and the specific information. This achieves that the data receiving apparatus selectively receives and stores each module.

Further, in the data receiving apparatus according to the present invention, each of the unique modules may have been encrypted to be decryptable with a specific decryption key. Each piece of the module information may include identification information relating to the specific decryption key corresponding to the unique modules. The specific information may include: (1) the specific decryption key used to decrypt each of the unique modules that is executable and is to be stored by the data receiving apparatus; and (2) identification information relating to the specific decryption key. The determining means may determine that each of the unique modules is executable and is to be stored by the data receiving apparatus when the module information includes identification information that matches the identification information included in the specific information. The storing means, when the determining means determines that each of the modules is executable and is to be stored by the data receiving apparatus, receives the module, may decrypt the module with the corresponding decryption key included in the identification information, and stores the module being executable in the predetermined device.

With this construction, the data receiving apparatus decrypts and stores only a module that is decryptable with decryption keys in possession. This means that each module is selectively received and stored. In addition, when a module is not decryptable with any decryption keys stored in the data receiving apparatus, the module is non-executable, so that data security is improved.

Further, in the data receiving apparatus according to the present invention, the storing means, when the determining means does not determine that each of the modules is executable and is to be stored by the data receiving apparatus, may further receive the module and store the non-decrypted and thus non-executable module in the predetermined device.

With this construction, each module is received and stored even if the module is not decryptable with any decryption keys stored at that time. This eliminates the need to receive the same module again when a corresponding decryption key is acquired. In stead, the module stored without decryption is decrypted and then stored in an executable state.

Further, the data receiving apparatus according to the present invention, may further comprise decryption key acquiring means, detecting means, and decrypting means. The decryption key acquiring means externally acquires a decryption key that is not recorded in the recording means to record the newly acquired decryption key in the recording means. The detecting means detects, if any module is stored without decrypting and thus being non-executable, a module that is decryptable with the newly acquired decryption key. The decrypting means decrypts the module detected by the detecting means and storing the decrypted module being executable in the predetermined device.

With this construction, the need to receive the same module once received is eliminated. When a decryption key is newly and externally acquired, the module stored without decryption and thus in a-non-executable state is decrypted with the new decryption key and then stored in the predetermined device in an executable state.

Alternatively, in the data receiving apparatus according to the present invention, the storing means (1) when the determining means determines that each of the modules is executable and is to be stored by the data receiving apparatus, may receive and temporarily store the module, and (2) when the determining means does not determine that each of the modules is executable and is to be stored by the data receiving apparatus, and when there is any module temporarily stored, may store the temporarily stored module in the predetermined device in a manner to overwrite a corresponding module stored therein during the time the module not to be stored is being transmitted.

With this construction, the module stored in the predetermined device is overwritten during the time modules for other data receiving apparatus are being transmitted.

Accordingly, data updation is carried out effectively even if the data receiving apparatus is incapable of performing temporarily storage of a module and overwriting of a module at the same time in parallel. In addition, a RAM used to temporarily store modules may be smaller in capacity.

Further, in the data receiving apparatus according to the present invention, each set of the control program data may be (1) a set of data each targeted for a different data receiving apparatus model, (2) a set data targeted for the same data receiving apparatus model but in a different version, or (3) a set of data targeted for a different data receiving apparatus model and in a different version. The module information may include information relating to a target data receiving apparatus model, a version of the unique module, or both a version and a target data receiving apparatus model. The specific information may include its own data receiving apparatus model, a desired version of unique module, or both its own data receiving apparatus model and the desired version of unique module. The determining means may determine that each of the unique modules is executable and is to be stored by the data receiving apparatus when the module information indicates that the module is targeted for the data receiving apparatus and a desired version.

This construction makes it possible to effectively receive control program data targeted for various data receiving apparatus models, various versions of control program data, or various version of control program data targeted for various data receiving apparatus models.

Further, in the data receiving apparatus according to the present invention, the determining means may include version holding means, model determining means, and version determining means. The version holding means holds a version of each of the modules being executable and stored, in advance, in the predetermined device. The model determining means determines whether the module information indicates that the module is targeted for the data receiving apparatus. The version determining means determines, when the model determining means determines that the module is targeted for the data receiving apparatus, whether a version indicated by the module information is newer than the version held by the holding means and for designating, when the module is determined to be a newer version, the version as the desired version.

With this construction, only a newer version module is acquired.

Further, the data receiving apparatus according to the present invention, may further comprise presenting means, and accepting means. The presenting means presents to a user information relating to a currently available version for rewrite. The accepting means accepts a desired version designation from the user based on the presented information by the presenting means. The determining means may include model determining means, and version determining means. The model determining means determines whether the module information indicates that the module is targeted for the data receiving apparatus. The version determining means determines, when the model determining means determines that the module is targeted for the data receiving apparatus, whether a version indicated by the module information matches the desired version accepted by the accepting means to designate the version determined to match the accepted desired version as the desired version.

This construction allows the user to select a desired version from among a plurality of versions that are executable and are to be stored by his own data receiving apparatus.

Accordingly, the data transmitting apparatus is allowed to transmit a plurality of versions each targeted for the same model at the same time. Therefore, for example, when a broadcaster wants to transmit two visions of modules for the same model, such as a bug-patched version and a function upgraded version, they can transmit those two versions at the same time instead of transmitting in a different time period, thereby saving trouble for switching modules to be transmitted.

Further, in the data receiving apparatus according to the present invention, the module information may include charge information, appended to each module or to each piece of module information, that indicates whether a charge is to be made for the module. The storing means may includes charge determining means, and charging means. The charge determining means determines whether a charge is to be made for each of the modules with reference to the charge information appended to the module or to the module information when the determining means determines the module is executable and is to be stored by the data receiving apparatus. The charging means performs charging processing on each of the modules when the charge determining means determines that a charge is to be made.

This construction allows the data receiving apparatus to handle chargeable data. In addition, charge processing is separately processed on each module or on each identification information, so that charge conditions are set in detail.

Further, in the data receiving apparatus according to the present invention, the storing means may include instruction command determining means and copying means. The instruction command determining means determines whether a substance of each of the modules is an instruction command that instructs the data receiving apparatus to use a previous version module when the determining means determines that the module is executable and is to be stored by the data receiving apparatus. The copying means assumes a previous version module that is stored, in advance, in the predetermined device and that corresponds to the module determined by the instruction command determining means to be the instruction command is overwritten with the desired version without changing the substance of the previous version module.

With this construction, a modules having the same substance as the previous version is not transmitted, so that processing by the data receiving apparatus is reduced.

Further, in the data receiving apparatus according to the present invention, at least one of the unique modules may be appended with information data relating to the control program data that includes the unique module or relating to the unique module. The storing means may include information presenting means. The information presenting means presents, if any information is attached to each of the modules, the information to the user during or after receiving the module, or during or after storing the module when the determining means determines that the module is executable and is to be stored by the data receiving apparatus.

Whit this construction, information about each module is presented to the user during or after receiving the module, or during or after storing the module.

In another aspect, the present invention provides a data transmitting program for use by a data transmitting apparatus that transmits data to a plurality of data receiving apparatuses. The data transmitting program according to the present invention makes the data receiving apparatus perform: an acquiring step for acquiring a plurality of sets selection data, each set of which is targeted for one data receiving apparatus model; an organizing step for comparing the plurality of sets of selection data and extracting common data and unique data, the common data being a portion of one set of selection data that is also contained in one or more other sets of selection data and the unique data being a remaining portion in each set of selection data left after excluding the common data; and a transmitting step for transmitting the common data and the unique data together to the plurality of data receiving apparatuses.

With this construction, common data is extracted and transmitted without repeatedly transmitting the same data, so that the total amount of data to be transmitted is decreased.

Therefore, data is effectively transmitted within a limited bandwidth.

Further, in the data transmitting program according to the present invention, each set of the selection data acquired in the acquiring step may be composed of a plurality of module and recording means included in the data transmitting apparatus records, in advance, an encryption key that corresponds to each of the module extracted as the unique data extracted in the organizing step. The organizing step may include (1) a common data extracting substep for extracting, as the common data, a module of which substance is common among all the sets of selection data by comparing the plurality of sets of selection data module by module, (2) a unique data extracting substep for extracting, as the unique data, all the modules other than the modules extracted in the common data extracting substep, and (3) an encrypting substep for encrypting each of the modules extracted as the unique data using the corresponding encryption key recorded in the recording means. The transmitting step may transmit the modules extracted as the common data in the common data extracting substep and the modules encrypted in the encrypting substep together to the plurality of data receiving apparatuses.

With this construction, each module extracted as common data is encrypted with a corresponding encryption key and then transmitted. Thus, the encrypted modules are decryptable and available only to a data receiving apparatus having a corresponding decryption key.

Further, in the data transmitting program according to the present invention, the organizing step may (1) extract, as the common data, a portion of selection data that is common among two or more sets of selection data, (2) append, to each piece of the extracted common data, all pieces of identification information relating to sets of the selection data from which the piece of the common data has been extracted, and (3) append, to each piece of the extracted unique data, one piece of identification information relating to one set of the selection data from which the piece of the unique data has been extracted. The transmitting step may transmit together (1) each piece of the common data together with all the pieces of identification information appended thereto, and (2) each piece of the unique data together with the one piece of identification information appended thereto.

With this construction, one piece of common data is transmitted together with identification information identifying a plurality of target data receiving apparatus models. Thus, the same data is suitably received and used by the plurality of data receiving apparatus models.

In another aspect, the present invention provides a data receiving program for use by a data receiving apparatus that receives and stores a set of control program data targeted for the data receiving apparatus selectively from among a plurality of sets of control program data transmitted from a data transmitting apparatus to a plurality of data receiving apparatuses, wherein: each set of the control program data has been divided into a plurality of modules and transmitted sequentially; the plurality of modules includes one or more unique modules that are the modules other than the modules being common among all the control program data; each of the unique modules is appended with a piece of module information that is used to determine whether the module is executable and is to be stored by each data receiving apparatus; and recording means included in the data receiving apparatus records, in advance, specific information for specifying a unique module that is executable and is to be stored by the data receiving apparatus. The data receiving program according to the present invention makes the data receiving apparatus perform: an obtaining step for obtaining module information appended to each of the unique modules; a determining step for determining whether each of the unique module is executable and is to be stored by the data receiving apparatus with reference to the module information and the specific information; and a storing step, when the determining step determines that each of the modules is executable and is to be stored by the data receiving apparatus, for receiving the module and for storing the module being executable in a predetermined device.

With this construction, it is determined whether a module is executable and is to be stored by the data receiving apparatus itself with reference to the module information and the specific information. This achieves that the data receiving apparatus selectively receives and stores each module.

Further, in the data receiving program according to the present invention, each of the unique modules may have been encrypted to be decryptable with a specific decryption key. Each piece of the module information may include identification information relating to the specific decryption key corresponding to the unique modules. The specific information may include (1) the specific decryption key used to decrypt each of the unique modules that is executable and is to be stored by the data receiving apparatus, and (2) identification information relating to the specific decryption key. The determining step may determine that each of the unique modules is executable and is to be stored by the data receiving apparatus when the module information includes identification information that matches the identification information included in the specific information. The storing step, when the determining step determines that each of the module is executable and is to be stored by the data receiving apparatus, may receive the module, decrypt the module with the corresponding decryption key included in the identification information, and store the module being executable in the predetermined device.

With this construction, the data receiving apparatus decrypts and stores only a module that is decryptable with decryption keys in possession. This means that each module is selectively received and stored. In addition, when a module is not decryptable with any decryption keys stored in the data receiving apparatus, the module is non-executable, so that data security is improved.

Further, in the data receiving program according to the present invention, the storing steps (1) when the determining step determines that each of the module is executable and is to be stored by the data receiving apparatus, may receive and temporarily store the module, and (2) when the determining step does not determine that each of the modules is executable and is to be stored by the data receiving apparatus, and when there is any module temporarily stored, may store the temporarily stored module in the predetermined device in a manner to overwrite a corresponding module stored therein during the time the module not to be stored is being transmitted.

With this construction, the module stored in the predetermined device is overwritten during the time modules for other data receiving apparatus are being transmitted.

Accordingly, data updation is carried out effectively even if the data receiving apparatus is incapable of performing temporarily storage of a module and overwriting of a module at the same time in parallel. In addition, a RAM used to temporarily store modules may be smaller in capacity.

In another aspect, the present invention provides a computer-readable storage medium storing a data transmitting program for use by a data transmitting apparatus that transmits data to a plurality of data receiving apparatuses. Here, the data transmitting program makes the data transmitting apparatus perform: an acquiring step for acquiring a plurality of sets selection data, each set of which is targeted for one data receiving apparatus model; an organizing step for comparing the plurality of sets of selection data and extracting common data and unique data, the common data being a portion of one set of selection data that is also contained in one or more other sets of selection data and the unique data being a remaining portion in each set of selection data left after excluding the common data; and a transmitting step for collectively transmitting the common data and the unique data to the plurality of data receiving apparatuses.

With this construction, common data is extracted and transmitted without repeatedly transmitting the same data, so that the total amount of data to be transmitted is decreased.

Therefore, data is effectively transmitted within a limited bandwidth.

Further, in the data transmitting program stored in the computer-readable storage medium according to the present invention, each set of the selection data acquired in the acquiring step may be composed of a plurality of modules and recording means included in the data transmitting apparatus may record, in advance, an encryption key that corresponds to each of the modules extracted as the unique data in the organizing step. The organizing step may include (1) a common data extracting substep for extracting, as the common data, a module of which substance is common among all the sets of selection data by comparing the plurality of sets of selection data module by module, (2) a unique data extracting substep for extracting, as the unique data, all the modules other than the modules extracted in the common data extracting substep, (3) an encrypting substep for encrypting each of the modules extracted as the unique data using the corresponding encryption key recorded in the recording means, and the transmitting step transmits the modules extracted as the common data in the common data extracting substep together with the modules encrypted in the encrypting substep collectively to the plurality of data receiving apparatuses.

With this construction, each module extracted as common data is encrypted with a corresponding encryption key and then transmitted. Thus, the encrypted modules are decryptable and available only to a data receiving apparatus having a corresponding decryption key.

Further, in the data transmitting program stored in the computer-readable storage medium the according to the present invention, the organizing step may (1) extract, as the common data, a portion of selection data that is common among two or more sets of selection data, (2) append, to each piece of the extracted common data, all pieces of identification information relating to sets of the selection data from which the piece of the common data has been extracted, and (3) append, to each piece of the extracted unique data, one piece of identification information relating to one set of the selection data from which the piece of the unique data has been extracted. The transmitting step may collectively transmit (1) each piece of the common data together with all the pieces of identification information appended thereto, and (2) each piece of the unique data together with the one piece of identification information appended thereto.

With this construction, one piece of common data is transmitted together with identification information identifying a plurality of target data receiving apparatus models. Thus, the same data is suitably received and used by the plurality of data receiving apparatus models.

In another aspect, the present invention provides a computer-readable storage medium storing a data receiving program for use by a data receiving apparatus that receives and stores a set of control program data targeted for the data receiving apparatus selectively from among a plurality of sets of control program data transmitted from a data transmitting apparatus to a plurality of data receiving apparatuses, wherein: each set of the control program data has been divided into a plurality of modules and transmitted sequentially; the plurality of modules includes one or more unique modules that are the modules other than the modules being common among all the control program data; each of the unique modules is appended with a piece of module information that is used to determine whether the module is executable and is to be stored by each data receiving apparatus; and recording means included in the data receiving apparatus records, in advance, specific information for specifying a unique module that is executable and is to be stored by the data receiving apparatus. Here, the data receiving program makes the data receiving apparatus perform; an obtaining step for obtaining module information appended to each of the unique modules; a determining step for determining whether each of the unique module is executable and is to be stored by the data receiving apparatus with reference to the module information and the specific information; and a storing step, when the determining step determines that each of the modules is executable and is to be stored by the data receiving apparatus, for receiving the module and for storing the module being executable in a predetermined device.

With this construction, it is determined whether a module is executable and is to be stored by the data receiving apparatus itself with reference to the module information and the specific information. This achieves that the data receiving apparatus selectively receives and stores each module.

Further, in the data receiving program stored in the computer-readable storage medium according to the present invention, each of the unique modules may have been encrypted to be decryptable with a specific decryption key, and each piece of the module information may include identification information relating to the specific decryption key corresponding to the unique modules. The specific information may include (1) the specific decryption key used to decrypt each of the unique modules that is executable and is to be stored by the data receiving apparatus, and (2) identification information relating to the specific decryption key. The determining step may determine that each of the unique modules is executable and is to be stored by the data receiving apparatus when the module information includes identification information that matches the identification information included in the specific information. The storing step, when the determining step determines that each of the module is executable and is to be stored by the data receiving apparatus, receives the module, may decrypt the module with the corresponding decryption key included in the identification information, and store the module being executable in the predetermined device.

With this construction, the data receiving apparatus decrypts and stores only a module that is decryptable with decryption keys in possession. This means that each module is selectively received and stored. In addition, when a module is not decryptable with any decryption keys stored in the data receiving apparatus, the module is non-executable, so that data security is improved.

Further, in the data receiving program stored in the computer-readable storage medium according to the present invention, the storing step (1) when the determining step determines that each of the module is executable and is to be stored by the data receiving apparatus, may receive and temporarily store the module, and (2) when the determining step does not determine that each of the modules is executable and is to be stored by the data receiving apparatus, and when there is any module temporarily stored, may store the temporarily stored module in the predetermined device in a manner to overwrite a corresponding module stored therein during the time the module not to be stored is being transmitted.

With this construction, the module stored in the predetermined device is overwritten during the time modules for other data receiving apparatus are being transmitted.

Accordingly, data updation is carried out effectively even if the data receiving apparatus is incapable of performing temporarily storage of a module and overwriting of a module at the same time in parallel. In addition, a RAM used to temporarily store modules may be smaller in capacity.

### BRIEF DESCRIPTION OF THE DRAWINGS

FIG. 1 is a schematic view showing a data transmitting apparatus consistent with the embodiment 1 of the present invention;

FIG. 2 is a schematic view showing a data receiving apparatus consistent with the embodiment 1 of the present invention;

FIG. 3 is a view showing the flow of data transmission procedure performed by the data transmitting apparatus consistent with the embodiment 1 of the present invention;

FIG. 4 is a view showing the flow of download procedure performed by the data receiving apparatus consistent with the embodiment 1 of the present invention;

FIG. 5 is a schematic view showing a data transmitting apparatus consistent with the embodiment 2 of the present invention;

FIG. 6 is a schematic view showing a data receiving apparatus consistent with the embodiment 2 of the present invention;

FIG. 7 is a view showing the flow of data transmission procedure performed by the data transmitting apparatus consistent with the embodiment 2 of the present invention;

FIG. 8 is a view showing the flow of download procedure performed by the data receiving apparatus consistent with the embodiment 2 of the present invention;

FIG. 9 is a schematic view showing a data transmitting apparatus consistent with the embodiment 3 of the present invention;

FIG. 10 is a schematic view showing a data transmitting apparatus consistent with the embodiment 3 of the present invention;

FIG. 11 is a schematic view showing a data receiving apparatus consistent with the embodiment 3 of the present invention;

FIG. 12 is a view showing the flow of download procedure performed by the data receiving apparatus consistent with the embodiment 3 of the present invention;

FIG. 13 is a view showing module structures of each set of download data targeted for the models 1, 2, and 3, respectively;

FIG. 14 is a view showing the transmission sequence when each module shown in FIG. 13 is transmitted in the sequence of the models 1, 2 and then 3;

FIG. 15 is a view showing the transmission sequence of modules shown in FIG. 13 when modules of the same attribute are transmitted consecutively;

FIG. 16 is a schematic view showing a data transmitting apparatus consistent with the embodiment 4 of the present invention;

FIG. 17 is a schematic view showing a data transmitting apparatus consistent with the embodiment 4 of the present invention;

FIG. 18 is a schematic view showing a data receiving apparatus consistent with the embodiment 4 of the present invention;

FIG. 19 is a schematic view showing a data transmitting apparatus consistent with the embodiment 5 of the present invention;

FIG. 20 is a schematic view showing a data transmitting apparatus consistent with the embodiment 5 of the present invention;

FIG. 21 is a schematic view showing a data receiving apparatus consistent with the embodiment 5 of the present invention;

FIG. 22 is a view showing the flow of data transmission performed by the data transmitting apparatus consistent with the embodiment 5 of the present invention;

FIG. 23 is a view showing the flow of data transmission performed by the data transiting apparatus consistent with the embodiment 5 of the present invention;

FIG. 24 is a view showing the flow of download procedure performed by the data receiving apparatus consistent with the embodiment 5;

FIG. 25 is a view showing the flow of download procedure performed by the data receiving apparatus consistent with the embodiment 5;

FIG. 26 is a view showing module structures of two versions of download data for model 1 and another two versions of download data for model 2;

FIG. 27 is a view showing the transmission sequence when each module shown in FIG. 26 is transmitted in the sequence of the models 1 and then 2;

FIG. 28 is a schematic view showing a data transmitting apparatus consistent with the embodiment 6 of the present invention;

FIG. 29 is a view showing the transmission sequence in the case of appending mail data about function-upgrade to each module of the corresponding model;

FIG. 30 is a view showing the transmission sequence in the case of appending bitmap data about function-upgrade to each module of the corresponding model;

FIG. 31 is a schematic view showing a data receiving apparatus consistent with the embodiment 6 of the present invention;

FIG. 32 is a view showing examples of mail data display, which provides information to the user;

FIG. 33 is a view showing examples of bitmap data display, which provides information to the user;

FIG. 34is a view showing the flow of data transmission procedure performed by the data transmitting apparatus consistent with the embodiment 6 of the present invention;

FIG. 35 is a view showing the flow of download procedure performed by the data receiving apparatus consistent with the embodiment 6 of the present invention;

FIG. 36 is a view showing a data transmitting apparatus (host station) consistent with the embodiment 7 of the present invention;

FIG. 37 is a view showing an example of a program data that the information source managing unit 141 manages;

FIG. 38 is a view showing an example of program data including subprogram modules that have been encrypted by the encrypting unit 143;

FIG. 39 is a view showing a data receiving apparatus consistent with the embodiment 7 of the present invention;

FIGS. 40A, 40B and 40C are views showing examples of program data, which include subprogram modules decrypted by the decrypting unit 155;

FIG. 41 is a view showing the flow of data transmission performed by the data transmitting apparatus consistent with the embodiment 7 of the present invention;

FIG. 42 is a view showing the flow of download procedure performed by the data receiving apparatus consistent with the embodiment 7 of the present invention;

FIG. 43 is a view showing the flow of program execution procedure performed by the data receiving apparatus consistent with the embodiment 7;

FIG. 44 is a view showing the flow of procedure for decryption key acquiring and decrypting preformed by the data receiving apparatus consistent with the embodiment 7 of the present invention;

FIG. 45 is a view showing the flow of download procedure performed by the data receiving apparatus consistent with the embodiment 8 of the present invention;

FIG. 46 is a schematic block diagram showing a MPEG2-compliant digital broadcast transmitter;

FIG. 47 is a schematic block diagram showing a MPEG-2 compliant digital broadcast receiver;

FIG. 48 is a view showing a pattern of download data transmission in digital broad casting;

FIG. 49A is a schematic view showing multi-stream transmission; and

FIG. 49B is a schematic view showing single-stream transmission.

### BEST MODE FOR CARRYING OUT THE INVENTION

### EMBODIMENT 1

<Overview>

In an embodiment 1 of the present invention, a data transmitting apparatus separates a plurality of sets of download data, each of which is targeted for one model, into the flowing two types: data that is common among two or more models and data that is not common between any models. Common data is appended with identification information identifying all the corresponding models, and only one set of common data per substance is transmitted in the entire transmission. Each set of unique data is appended with identification information identifying each model and transmitted. A data receiving apparatus downloads only data targeted for that receiving apparatus itself according to the identification information.

<Construction of Data Transmitting Apparatus>

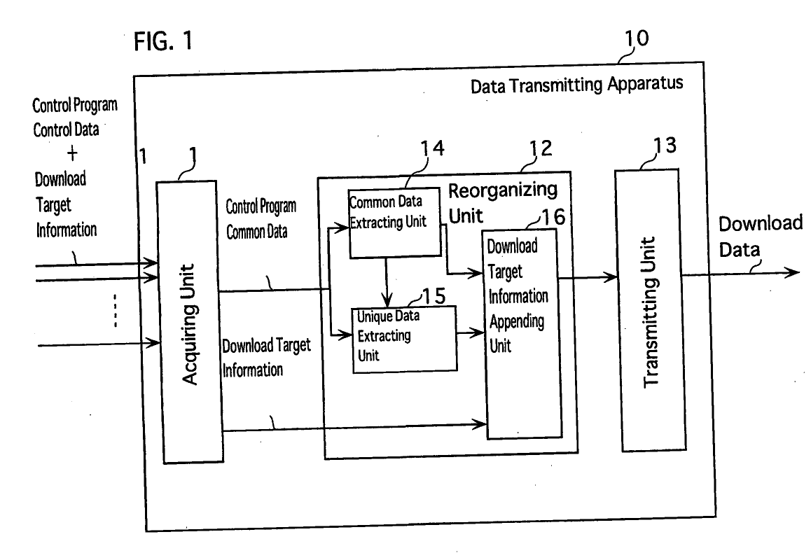

FIG. 1 is a schematic view showing a data transmitting apparatus consistent with the embodiment 1 of the present invention.

The data transmitting apparatus 10 shown in FIG. 1 comprises an acquiring unit 11, a reorganization unit 12, and a transmitting unit 13.

The acquiring unit 11 acquires a plurality of sets of download data, each of which is targeted for one model. Here, download data for each model includes a control program, control data, and download target information. The “download target information” used herein referrers to the information for identifying each set of download data and indicating the target by which the download data should be downloaded. In this case, the download target information includes (1) maker information and (2) model information both indicating the maker and the model of a data receiving apparatus by which the download data should be downloaded, and (3) version information indicating the version of the download data.

The reorganizing unit 12 reorganizes the plurality of sets of download data for plurality of models, whereby each set of common data that is common among two or more models is appended with all the pieces of download target information of the corresponding sets of download data, while each set of unique data, or equivalently, the remaining data after excluding the common data, is appended with one piece of download target information of the corresponding set of download data. The reorganizing unit 12 comprises a common data extracting unit 14, a unique data extracting unit 15, and a download target information appending unit 16.

The common data extracting unit 14 extracts data that is common among two or more models through comparisons of each set of download data acquired by the acquiring unit 11.

The unique data extracting unit 15 extracts data that is unique to each set of download data by excluding, from each set, the common data extracted by the common data extracting unit 14.

The download data information appending unit 16 appends, to each set of common data, download target information of all the corresponding common data extracted by the common data extracting unit 14, and appends, to each set of unique data extracted by the unique data extracting unit 15, download target information of one corresponding set of download data.

The transmitting unit 13 packetizes the download data for the plurality of models, which includes sets of common data, each having a plurality of pieces of identification information appended thereto by the download target information appending unit 16, and sets of unique data, each having one piece of identification information appended thereto. Then, the transmitting unit 13 multiplexes the resulting packets into one modulated wave and transmits to a plurality data receiving apparatus of various models within a period that is separately instructed by an operator.

<Construction of Data Receiving Apparatus>

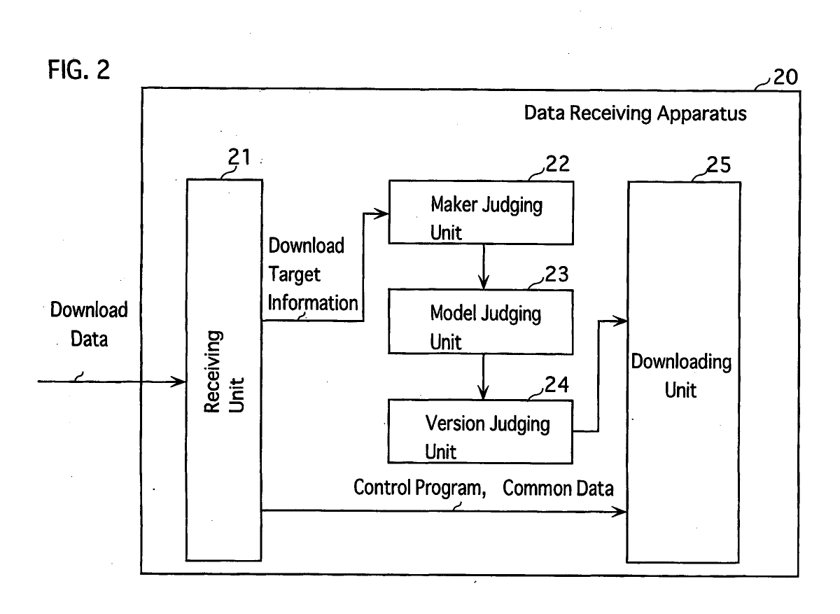

FIG. 2 is a schematic view showing a data receiving apparatus consistent with the embodiment 1 of the present invention.

The data receiving apparatus 20 shown in FIG. 2 comprise a receiving unit 21, a maker judging unit 22, a model judging unit 23, a version judging unit 24, and a downloading unit 25.

The receiving unit 21 receives the download data transmitted from data transmitting apparatus 10. Here, the download data received is composed of sets of common data, each of which is appended with download target information of a plurality of models, as well as sets of common data, each of which is appended with download target information of one model. In practice, the download data is transmitted in packets, and the receiving unit 21 receives necessary packets with reference to download control information appended to each packet and reconstitutes the download data. Yet, description thereof is immaterial to the present invention and thus omitted.

The maker judging unit 22 previously stores maker information indicating the maker of the data receiving apparatus 20 itself. Here, the maker judging unit 22 looks up the download data received by the receiving unit 21 to extract maker information included in the download target information appended to the common data or unique data, and judges whether the thus extracted maker information matches the stored maker information.

The model judging unit 23 previously stores model information indicating the model of the data receiving apparatus 20 itself. Here, the model judging unit 23 looks up the download target information appended to the common data or unique data that is judged by the maker judging unit 22 to be maker-matched to extract model information, and judges whether the thus extracted model information matches the stored model information.

The version judging unit 24 previously stores version information indicating the version of a control program and control data that the data receiving apparatus 20 itself stores. Here, the version judging unit 24 looks up the download target information appended to the common data or unique data that is judged by the model judging unit 23 to be model-matched to extract version information, and judges whether the thus extracted version information indicates a newer version than the one indicated by the stored version information.

The downloading unit 25 downloads only the common data or unique data that is judged by the version judging unit 24 to be a newer version.

It should be noted that whether to download the download data is judged independently from the download target information. Thus, download target information may be separately received first, and the common data or unique data may be received only when it is judged to download the data.

<Data Transmission Procedure>

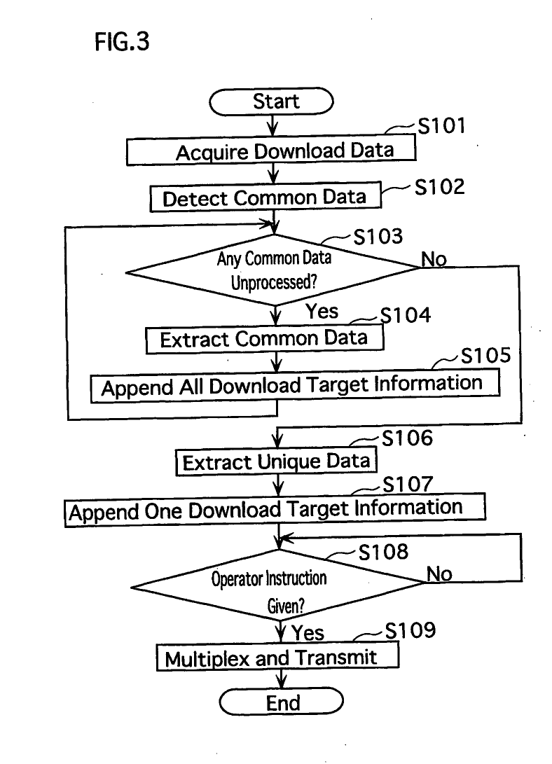

FIG. 3 is a view showing the flow of data transmission procedure performed by the data transmitting apparatus consistent with the embodiment 1 of the present invention.

Hereinafter, the data transmission procedure is described in outline with reference to FIG. 3.

(1) The acquiring unit 11 acquires a plurality of sets of download data, each of which is targeted for one model (step S101).

(2) The common data extracting unit 14 makes model-by-model comparisons among the sets of download data acquired by the acquiring unit 11 so as to detect common data that is common among two or more models (step S102).

(3) The common data extracting unit 14 judges whether there is any other common data left unprocessed (step S103).

(4) The common data extracting unit 14 extracts the unprocessed common data, if any (step S104).

(5) The download target information appending unit 16 appends, to each set of extracted common data, all the pieces of download target information of the download data that includes the common data (step S105).

(6) When there is no more common data left unprocessed, the unique data extracting unit 15 extracts unique data from each set of download data acquired by the acquiring unit 11 by excluding, from each set, all the common data extracted by the common data extracting unit 14 (step S106).

(7) The download target information appending unit 16 appends, to each set of extracted unique data, one piece of download data information of corresponding download data (step S107).

(8) The data transmitting apparatus waits until the operator instructs to transmit download data (step S108)

(9) Upon receiving an operator's instruction to transmit download data, the transmitting unit 13 packetizes the download data targeted for plurality of models. The download data is composed of sets of common data, each of which is appended with a plurality of pieces of identification information, and sets of common data, each of which is appended with one piece of identification information. Then, the transmitting unit 13 multiplexes the resulting packets into one modulated wave to transmit (step S109).

<Download Procedure>

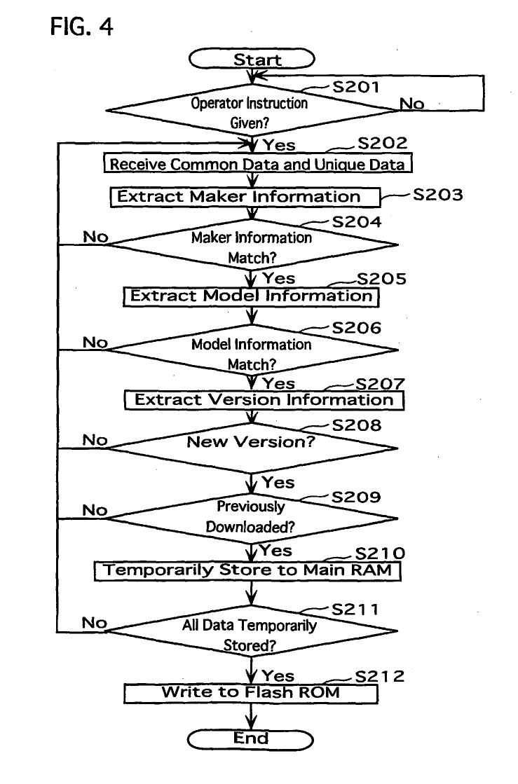

FIG. 4 is a view showing the flow of download procedure performed by the data receiving apparatus consistent with the embodiment 1 of the present invention.

Hereinafter, the download procedure is described in outline with reference to FIG. 4.

(1) The data receiving apparatus waits until a user to instruct to start downloading (step S201).

(2) Upon receiving a user's instruction to start downloading, the receiving unit 21 receives one set of the common data or unique data included in the download data transmitted from the data transmitting apparatus 10 (step S202).

(3) The maker judging unit 22 extracts the maker information from the download target information appended to the set of common data or unique data received (step S203)

(4) The maker judging unit 22 judges whether the extracted maker information matches the stored maker information (step S204).

(5) When it is judged that the maker information matches, the model judging unit 23 extracts the model information from the download target information appended to the current set of common data or unique data (step S205).

(6) The model judging unit 23 judges whether the extracted model information matches the stored model information (step S206).

(7) When it is judged that the model information matches, the version judging unit 24 extracts the version information from the download target information appended to the current set of common data or unique data (step S207).

(8) The version judging unit 24 judges whether the extracted version information indicates a newer version than the one indicated by the stored version information (step S208).

(9) When it is judged to be a newer version, the downloading unit 25 further judges whether the current set of common data or unique data has been downloaded previously (step S209).

(10) When it is judged that the current set of common data or unique data has not been downloaded yet, the downloading unit 25 temporarily stores the data in the main RAM (step S210).

(11) The downloading unit 25 judges whether all the common data and the unique data constituting the download data have been temporarily stored (step S211).

(12) When all the common data and the unique data necessary for the data receiving apparatus 20 itself have been temporarily stored, the downloading unit 25 writes the download data temporarily stored in the main RAM to the flash ROM (step S212).

<Conclusion>

As described above, according to the embodiment 1 of the present invention, data that is common among two or more models is extracted from download data, and only one set of common data per substance is transmitted. In so doing, the total amount of download data for a plurality of models is reduced.

The embodiment 1 of the present invention may be configured as follows: each set of download data acquired by the acquiring unit 11 is composed of a plurality of modules with different attributes representing their properties or types, so that each processing by the above components is performed on a module-by-module basis. In this case, the common data extracting unit 14 compares modules of the same attribute among the sets of download data acquired by the acquiring unit 11 so as to extract the modules having the same substance or equivalently the common data. The unique data extracting unit 15 extracts common data, or equivalently, the modules other than the modules extracted by the common data extracting unit 14.

### EMBODIMENT 2

<Overview>

In an embodiment 2 of the present invention, a data transmitting apparatus divides each set of download data targeted for one model into modules, and each module is recorded to database one by one. Upon recording, when the same module has been recorded already, only identification information of the corresponding model is additionally recorded. In this way, each module that is common among two or more models is appended with identification information indicating a plurality of models, while each module that is unique to one model is appended with identification information indicating one model. The resulting modules are then transmitted. A data receiving apparatus downloads only modules targeted for that receiving apparatus itself according to the identification information.

<Construction of Data Transmitting Apparatus>

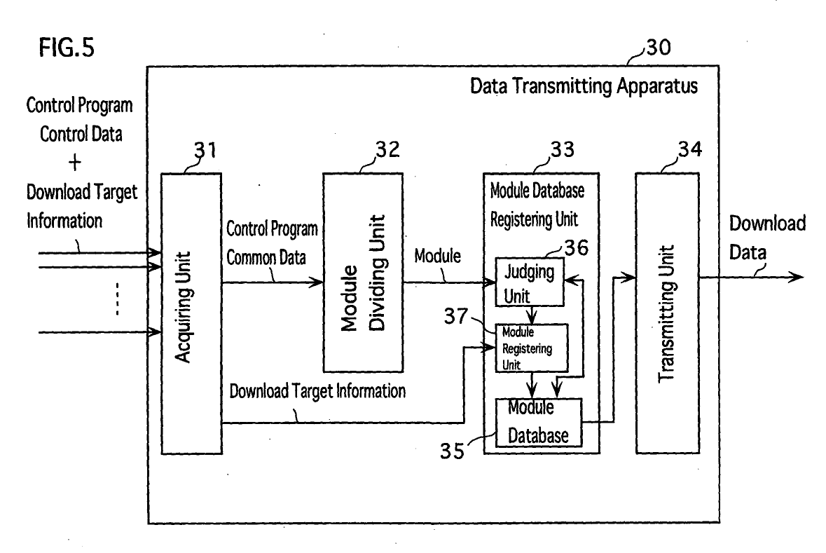

FIG. 5 is a schematic view showing a data transmitting apparatus consistent with the embodiment 2 of the present invention.

The data transmitting apparatus 30 shown in FIG. 5 comprises a data acquiring unit 30, a module dividing unit 32, a module database registering unit 33, and a transmitting unit 34.

The acquiring unit 31 acquires a plurality of sets of download data, each of which is targeted for one model. Here, download data for each model includes a control program, control data, and download target information.

The “modules” used herein refer to small units of a program or data according to their properties or types. For example, a module in a control program may be its application, library, device driver, or the like, and a module in control data may be its logo, font, or the like.

In addition, the control program and control data, which the acquiring unit 31 acquires, previously include data indicating a separating point between modules, and each module is previously appended attribute information indicating its own property and type. To be more specific by way of example, a control program and control data is separated by a header part indicating the beginning of the module, and the header part includes attribute information.

The module dividing unit 32 respectively divides the control program and control data acquired by the acquiring unit 31 into modules.

The module database registering unit 33 records each module that is common among two or more models together with download target information of all the corresponding download data, and records each of the remaining modules other than the above common modules together with download target information of each corresponding module. The module database registering unit 33 comprises a module database 35, a judging unit 36 and a module registering unit 37.

The module database 35 has an area for recording modules together with download target information appended thereto.

The judging unit 36 judges, on a module-by-module basis, whether there is a module, in the module database 35, having the same attribute and the substance as each modules divided by the module dividing unit 32.

When the judging unit 36 judges that there is no module having the same attribute and the substance, the module registering unit 37 additionally recodes the current module in the module database 35 together with the download target information of the corresponding download data. On the other hand, when the judging unit 36 judges that there is a module having the same attribute and the substance, the module registering unit 37 adds, to the module that is already recoded, only the download target information of the corresponding download data.

After the module database registering unit 33 has recorded all the download data to be transmitted, the transmitting unit 34 packetizes all the download data, that is all the modules recorded in the module database 35, multiplexes the resulting packets into one modulated wave to transmit.

<Construction of Data Receiving Apparatus>

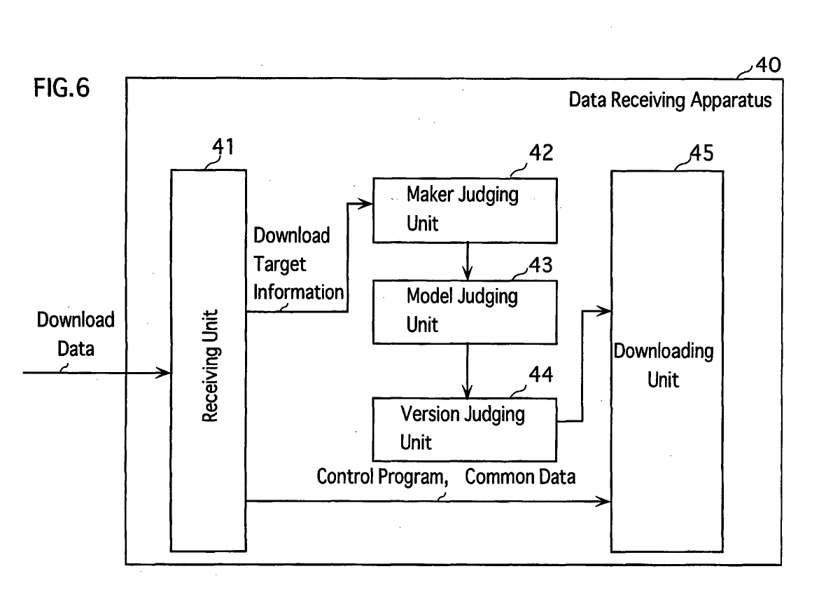

FIG. 6 is a schematic view showing a data receiving apparatus consistent with the embodiment 2 of the present invention.

The data receiving apparatus 40 shown in FIG. 6 comprises a receiving unit 41, a maker judging unit 42, a model judging unit 43, a version judging unit 44, and downloading unit 45.

The receiving unit 41 receives the download data transmitted from data transmitting apparatus 30. Here, the download data received is composed of a plurality of modules, each of which is appended with download target information indicating one or a plurality of models. In practice, each module is transmitted in packets.

Consequently, the receiving unit 41 receives necessary packets with reference to the download control information attached thereto and reconstitutes the modules. Yet, description thereof is immaterial to the present invention and thus omitted.

The maker judging unit 42 previously stores maker information indicating the maker of the data receiving apparatus 40 itself. Here, the maker judging unit 42 looks up the download target information appended to the modules constituting the download data received by the receiving unit 41 to extract maker information included in the download target information appended to each module, and judges whether the thus extracted maker information matches the stored maker information.

The model judging unit 43 previously stores model information indicating the model of the data receiving apparatus 40 itself. Here, the model judging unit 43 looks up the download target information appended to the modules that are judged by the maker judging unit 42 to be maker-matched to extract model information, and judges whether the thus extracted model information matches that stored model information.

The version judging unit 44 previously stores version information indicating the version of a control program and control data that the data receiving apparatus 40 itself stores. Here, the version judging unit 44 looks up the download target information appended to the modules that are judged by the model judging unit 43 to be model-matched to extract version information, and judges whether the thus extracted version information indicates a newer version than the one indicated by the stored version information.

The downloading unit 45 downloads only the modules that are judged by the version judging unit 44 to be a newer version.

It should be noted that whether to download the modules is judged independently from the download target information. Thus, download target information may be separately received first, and the modules may be received only when it is judged to download the modules.

<Data Transmission Procedure>

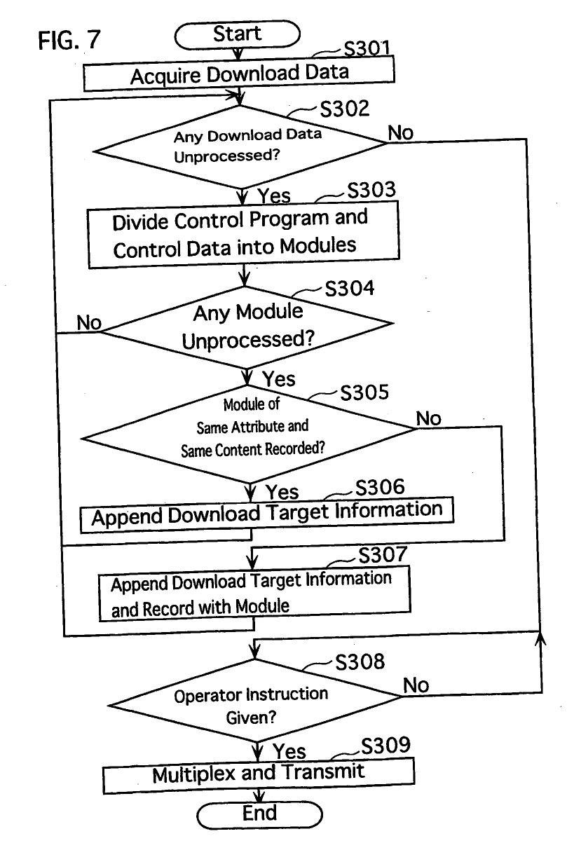

FIG. 7 is a view showing the flow of data transmission procedure performed by the data transmitting apparatus consistent with the embodiment 2 of the present invention.

Hereinafter, the data transmission procedure is described with reference to FIG. 7.

(1) The acquiring unit 31 acquires a plurality of sets of download data, each of which is targeted for one model (step S301).

(2) The acquiring unit 31 judges whether there is any download data left unprocessed (step S302). When all the sets of download data for all the models have been processed, the processing goes into standby and waits for an operator to instruct transmission.

(3) When it is judged that there is any download data left unprocessed, the module dividing unit 32 starts processing with any set of unprocessed download data. To begin with, the module dividing unit 32 divides the control program and the data in the current set of download data into modules (step S303).

(4) Then, the module dividing unit 32 judges whether there is any module left unprocessed (step S304). When all the modules for one model have been processed, processing of download data for another model is then stated.

(5) The module database registering unit 33 starts processing with any unprocessed module. To begin with, the judging unit 36 judges whether there is a module, in the module data base 35, having the same attribute and the substance as the current module (step S305).

(6) When there is a module having the same attribute and the substance, the module registering unit 37 adds the download target information of the download data being processed to the module of the same substance that is recorded in the module database 35 (step S306).

(7) When there is no module having the same attribute, or when there is merely a module having the same attribute but the different substance, the module registering unit 37 records the current module after appending the download target information of the download data being processed (step S307).

(8) When there is no module left unprocessed, the data receiving apparatus waits for the operator to instruct transmission (step S308).

(9) Upon receiving an operator's instruction to transmit the download data, the data transmitting unit 34 packetizes all the download data, or equivalently, all the modules recorded in the module database 35, multiplexes the resulting packets into one modulated wave to transmit (step S309).

<Download Procedure>

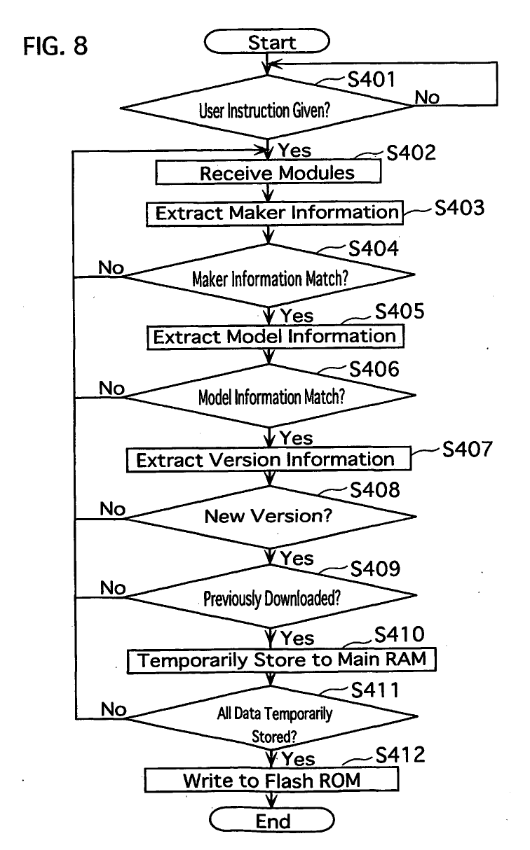

FIG. 8 is a view showing the flow of download procedure S performed by the data receiving apparatus consistent with the embodiment 2 of the present invention.

Hereinafter, the download procedure is described with reference to FIG. 8.

(1) The data receiving apparatus waits for a user to instruct to start downloading (step S401).

(2) Upon receiving an user's instruction to start downloading, the receiving unit 41 receives one module included in the download data transmitted from the data transmitting apparatus 30 (step S402).

(3) The maker judging unit 42 extracts maker information from the download target information appended to the received module (step S403).

(4) The maker judging unit 42 judges whether the extracted maker information matches the stored information (step S404).

(5) When it is judged that the maker information matches, the model judging unit 43 extracts model information from the download target information appended to the current module (step S405).

(6) The model judging unit 43 judges whether the extracted model information and the stored model information match (step S406).

(7) When it is judged that the model information matches, the version judging unit 44 extracts version information from the download target information appended to the current module (step S407).

(8) The version judging unit 44 judges whether the extracted information indicates a newer version than the one indicated by the stored version information (step S408).

(9) When it is judged to be a newer version, the downloading unit further judges the current module has been downloaded previously (step S409).

(10) When it is judged that the current module has not been downloaded yet, the downloading unit temporarily stores the module in the main RAM (step S410).

(11) The downloading unit judges whether all the modules constituting the download data have been temporarily stored (step S411).

(12) When all the modules necessary for the data receiving apparatus 40 itself have been temporarily stored, the downloading unit writes the download data in the main RAM to the flash ROM (step S412).

<Conclusion>

As described above, according to the embodiment 2 of the present invention, each module that is common among download data for two or more models is appended with a plurality of pieces of download data and then transmitted. In so doing, the total amount of download data for a plurality of models is reduced.

### EMBODIMENT 3

<Overview>

In an embodiment 3 of the present invention, a data transmitting apparatus consistent with the embodiment 1 or 2 transmits modules of the same attribute consecutively. When first receiving a module to be downloaded, a data receiving apparatus consistent with the embodiment 1 or 2 temporarily stores the module in a main RAM. While receiving a module not to be temporality stored, the data receiving apparatus overwrites the module stored in the flash ROM with the module that is stored in the main RAM.

<Construction of Data Transmitting Apparatus>

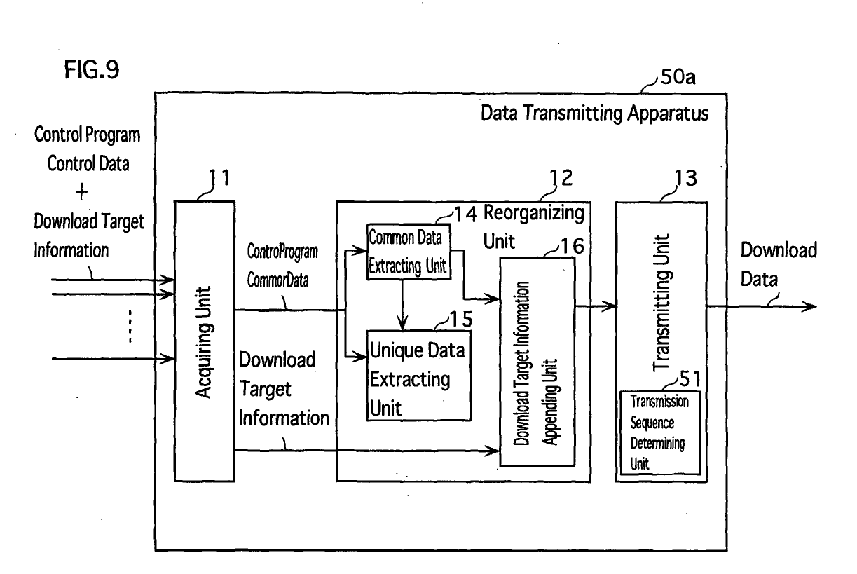

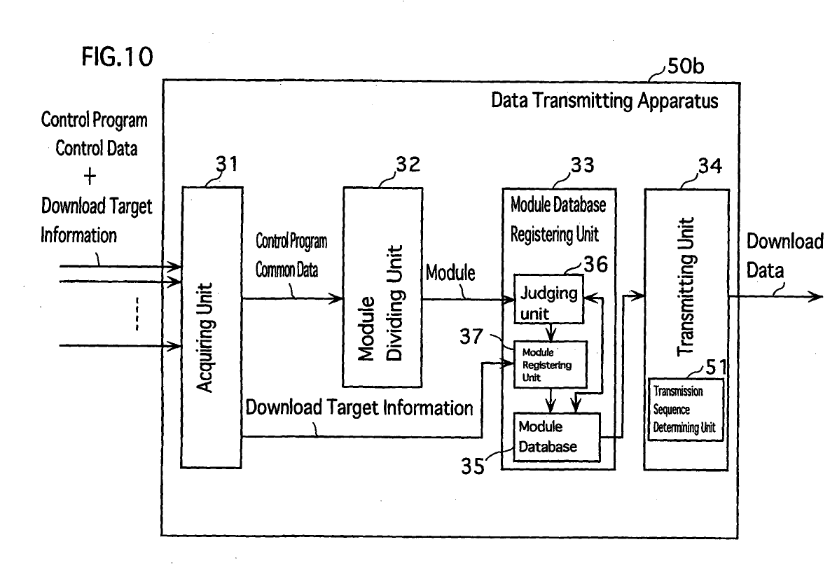

FIGS. 9 and 10 are schematic views each showing a data transmitting apparatus consistent with the embodiment 3 of the present invention.

The data transmitting apparatus 50a shown in FIG. 9 is based on the data transmitting apparatus 10 of the embodiment 1 in the case of performs module-by-module basis processing, but differs in that the transmitting unit 13 additionally comprises a transmission sequence determining unit 51, which determines the sequence of modules to be transmitted. The other components are the same as those of the data transmitting apparatus 10 of the embodiment 1, and thus description thereof is omitted.

The data transmitting apparatus 50b shown in FIG. 10 is based on the data transmitting apparatus 30 of the embodiment 2, but differs in that the transmitting unit 34 additionally comprises the transmission sequence determining unit 51. The other components are the same as those of the data transmitting apparatus 30, and thus description thereof is omitted.

The transmission sequence determining unit 51 determines the transmission sequence in a manner to consecutively transmit modules in different sets of download data if their attribute is the same.

<Construction of Data Receiving Apparatus>

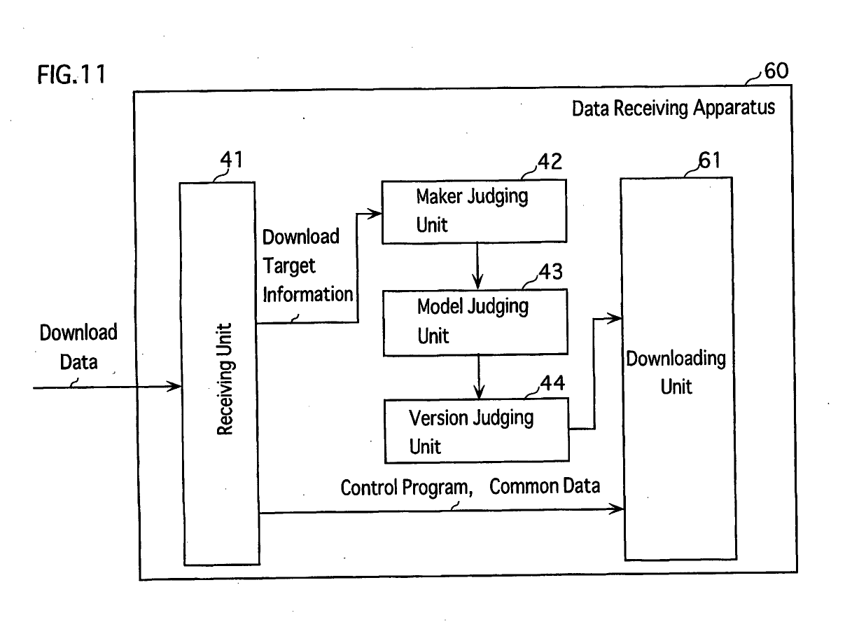

FIG. 11 is a schematic view showing a data receiving apparatus consistent with the embodiment 3 of the present invention.

The data receiving apparatus 60 shown in FIG. 11 is based on the data receiving apparatus 40 of the embodiment 2, but differs in that the downloading unit 45 is replaced with a downloading unit 61, which performs different downloading procedure. The other components are the same as those of the data receiving apparatus 40 of the embodiment 2, and thus description thereof is omitted.

When receiving a module to be downloaded, the downloading unit 61 temporarily stores the module in the main RAM. When receiving a module not to be downloaded, the downloading unit 61 overwrites the corresponding module in the flash ROM with the module temporarily stored in the main RAM, thereby downloading only modules that are determined to have the matched maker information and model information and to be a new version.

<Data Transmission Procedure>

The data transmission procedure in this embodiment is the same as that in the Embodiment 1 and 2. The only difference resides in the step S109 of the embodiment 1 or the step S309 of the embodiment 2. In these steps, the transmission sequence determining unit 51 determines the transmission sequence in a manner to consecutively transmit modules of the same attribute.

<Download Procedure>

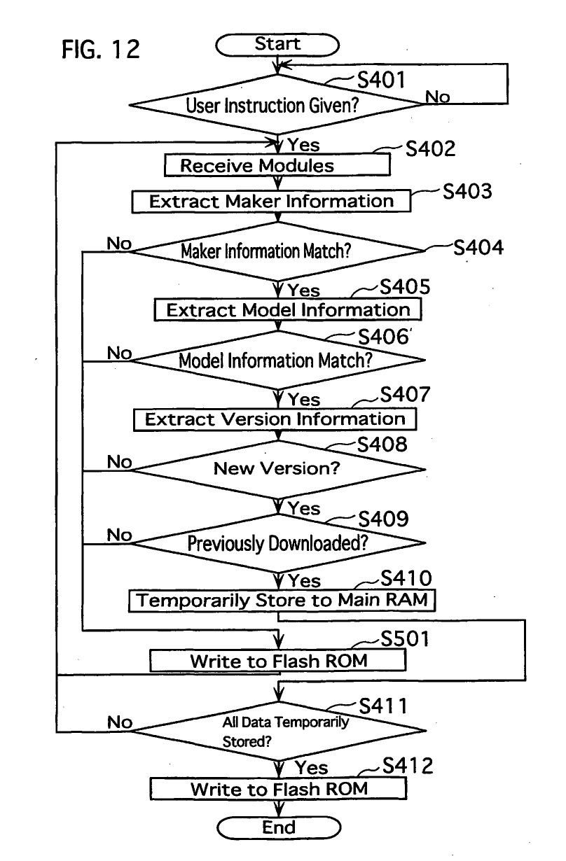

FIG. 12 is a view showing the flow of download procedure performed by the data receiving apparatus consistent with the embodiment 3 of the present invention.

The download procedure shown in FIG. 12 is the same as that of the embodiment 2 (see FIG. 8), but differs in an additional step that is performed when the steps S404, S406, S408, and S409 respectively result in the judgments that the maker information does not match, the model information does not match, the module is not a new version, and that the current module has been downloaded previously. In that additional step, the downloading unit overwrites the module stored in the flash ROM with the module temporarily stored in the main RAM, thereby erasing the temporarily stored module (step S501).

<Specific Example>

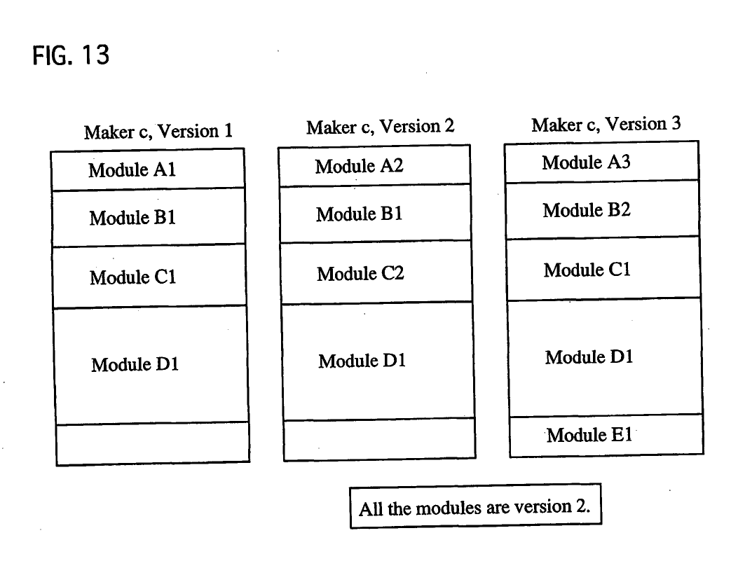

FIG. 13 is a view showing module structures of each set of download data targeted for the models 1, 2, and 3, respectively. Here, each alphabetic character represents the attribute of the module, and each numeric character following the alphabetic character represents the substance of the module. Accordingly, the modules with the same alphabetic character and different numeric characters have the same attribute but different substance, while the modules with the same alphabetic character and numeric character have the same version and substance.

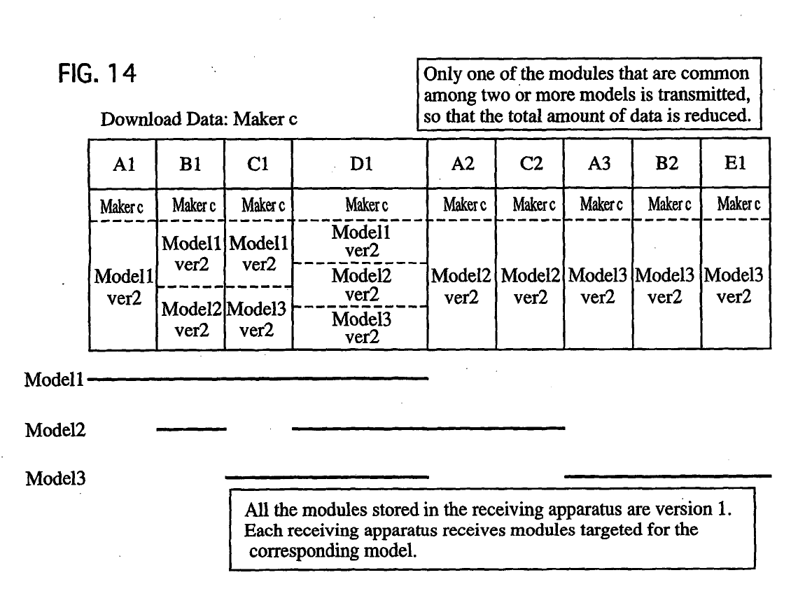

FIG. 14 is a view showing the transmission sequence when each module shown in FIG.13 is transmitted in the sequence of the models 1, 2 and then 3.

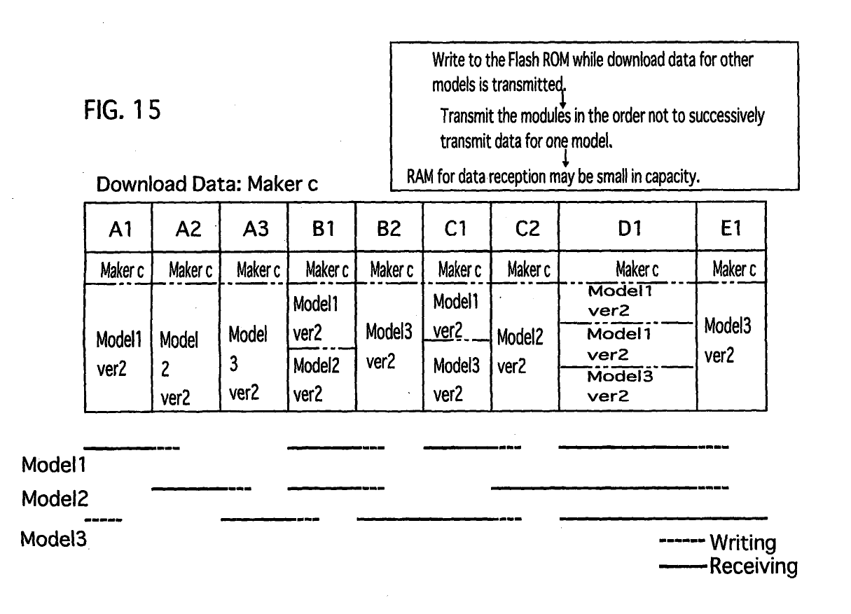

FIG. 15 is a view showing the transmission sequence of modules shown in FIG. 13 when modules of the same attribute are transmitted consecutively. Since the modules of the same attribute are transmitted consecutively, it turns out that modules for different models are transmitted by turns.

It should be noted that the numeric characters preceded by the letters, “Ver” in FIGS. 14 and 15 represent the version numbers of each download data. Here, all the download data is of version 2 in order to simplify the description.

<Conclusion>

As described above, according to the embodiment 3 of the present invention, modules of the same attribute are transmitted consecutively, which leads to that modules for different models are transmitted by turns. Further, the data receiving apparatus overwrites the flash ROM while receiving modules for other models, which leads to that download is performed effectively.

### EMBODIMENT 4

<Overview>

In an embodiment of the present invention, a data transmitting apparatus consistent with the embodiment 1, 2, or 3 further adds charge information to each module or to each piece of download target information appended to each module, and a data receiving apparatus consistent with the embodiment 1, 2, or 3 performs charge processing on a module-by-module basis with reference to the charge information.

<Construction of Data Transmitting Apparatus>

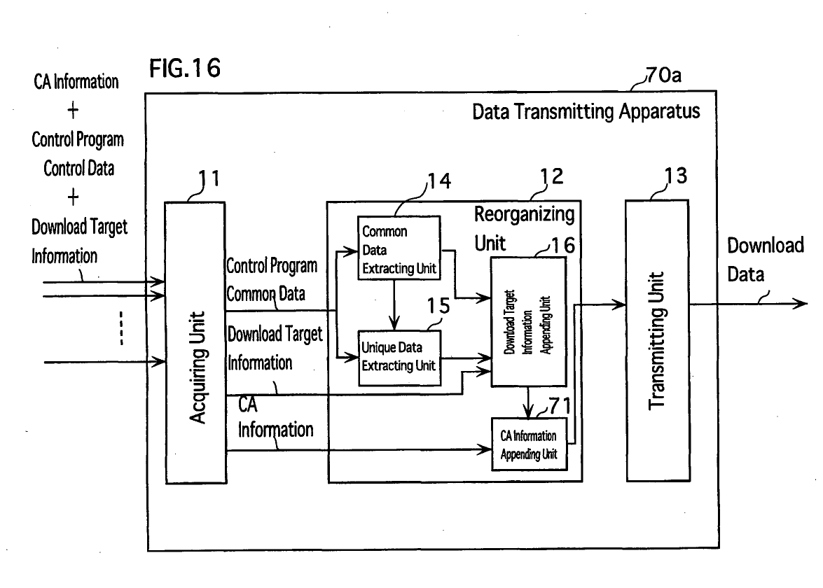

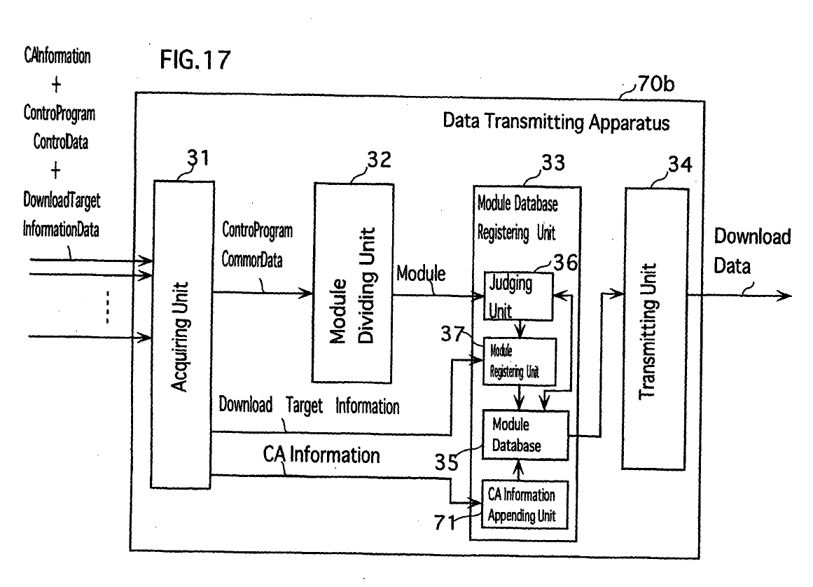

FIGS. 16 and 17 are schematic views each showing a data transmitting apparatus consistent with the embodiment 4 of the present invention.

The data transmitting apparatus 70a shown in FIG. 16 is based on the data transmitting apparatus 10 of the embodiment 1 in the case of performing module-by-module basis processing, or the data transmitting apparatus 50a of the embodiment 3, but differs in that the data reorganizing unit 12 additionally comprises a CA (Conditional Access) information appending unit 71. The CA information appending unit 71 appends, to each module or to each piece of download target information, CA information including whether any charge is required for the module or the data, an amount to be charged, and the like. The other components are the same as those of the data transmitting apparatus 10 of the embodiment 1 or the data transmitting apparatus 50a of the embodiment 3, and thus description thereof is omitted.

The data transmitting apparatus 70b shown in FIG. 17 is based on the data transmitting apparatus 30 of the embodiment 2 or the data transmitting apparatus 50b of the embodiment 3, but differs in that the module database registering unit 33 additionally comprises the CA information appending unit 71. The other components are the same as those of the data transmitting apparatus 30 of the embodiment 2 or the data transmitting apparatus 50b of the embodiment 3, and thus description thereof is omitted.

In this embodiment, CA information is appended to each module constituting download data, which is obtained by the acquiring unit 11 included in the data transmitting apparatus 10 of the embodiment 1, the acquiring unit 31 included in the data transmitting apparatus 30 of the embodiment 2, the acquiring unit 11 included in the data transmitting apparatus 50a of the embodiment 3, or the acquiring unit 11 included in the data transmitting apparatus 50b of the embodiment 3.

At the time of appending download target information, the CA information appending unit 71 adds CA information that is appended to the original module to each module or to each piece of download target information.

<Construction of Data Receiving Apparatus>

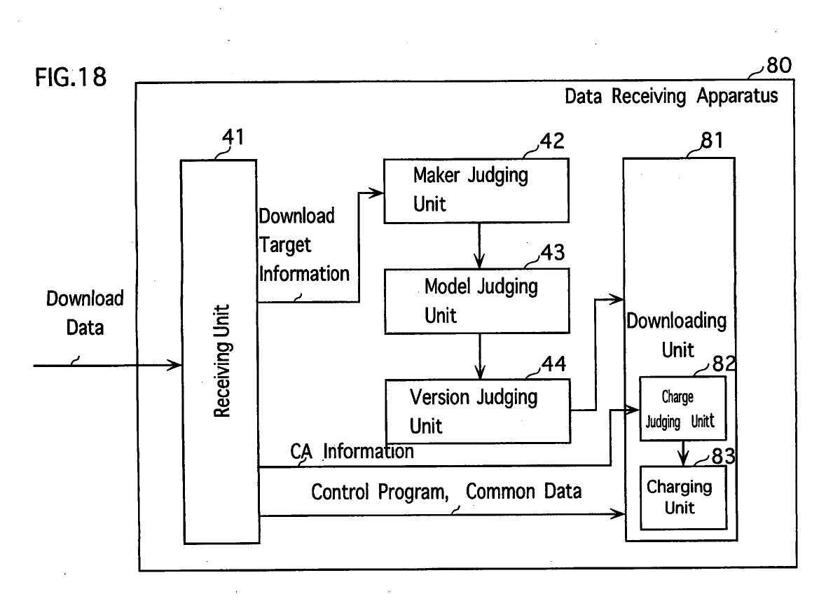

FIG. 18 is a schematic view showing a data receiving apparatus consistent with the embodiment 4 of the present invention.

The data receiving apparatus 80 shown in FIG. 18 is based on the data receiving apparatus 40 of the embodiment 2 or the data receiving apparatus 60 of the embodiment 4, but differs in that the downloading unit 45 or the downloading unit 61 is replaced with a downloading unit 81, which has a charging function in addition to the original functions. The other components are the same as those of the data receiving apparatus 40 of the embodiment 2 or the data receiving apparatus 60 of the embodiment 3, and thus description thereof is omitted.

The downloading unit 81 is constituted by adding a charge judging unit 82 and a charging unit 83 to the downloading unit 45 or 61.

In this embodiment, download data, which is received by the receiving unit 41 included in the data transmitting apparatus 40 of the embodiment 2 or in the data receiving apparatus 60 of the embodiment 3, includes CA information appended to each module or to each piece of download target information, which in turn is appended to each module.

At the time of downloading a module, which follows when the module is judged to be maker-matched, model-matched, and a new version, the charge judging unit 82 judges whether any charge is required with reference to the CA information appended to each module, or to the download target information appended to each module.

When the charge judging unit 82 judges that charge is required, the charging unit 83 performs charge processing on each module.

<Data Transmission Procedure>

The data transmission procedure in this embodiment is the same as that in the embodiment 1, 2 and 3, but differs in that the following operation is additionally performed in the steps S105 and S107 of the embodiment 1 or 3 and the steps S305 and S307 of the embodiment 2 or 3. In those steps, the CA information appending unit 71 adds, to each module or to each piece of download target information to be appended to each module, CA information that is appended to the original module.

<Download Procedure>

The download procedure in this embodiment is the same as that in the embodiment 2 or 3, but differs in that the following operation is additionally performed in the step S410 of the embodiment 2 or 3. In that step, the charge judging unit 82 judges whether any charge is required for each module, and the charging unit 83 performs charge processing after the charge judgment but before write operation to flash ROM.

Alternatively, for example, the data receiving apparatus may be constituted to (1) accumulate the charge information, such as charge amounts of all the modules, prior to the write operation to the flash ROM, (2) present the accumulated information to a user, and (3) accept a user-input as to whether to download the module, which is decided by the user with reference to the charge information.

<Conclusion>

As described above, according to the embodiment 4 of the present invention, when modules are common among two or more models, only one module per substance is transmitted together with all the corresponding pieces of download target information appended thereto. At this time, CA information is also appended to each piece of download target information. In so doing, charge processing is performed on a model-by-model and module-by-module basis, and yet the total amount of download data for a plurality of models is reduced.

### EMBODIMENT 5

<Overview>

In an embodiment 5 of the present invention, a data transmitting apparatus consistent with the embodiment 1, 2, 3, or 4 replaces a module with a copy command if the module has the same substance as a previous version of download data. When receiving the copy command, by which the module is replaced, a data receiving apparatus consistent with the embodiment 1, 2, 3, or 4 uses the module of the previous version instead of the current module.

<Construction of Data Transmitting Apparatus>

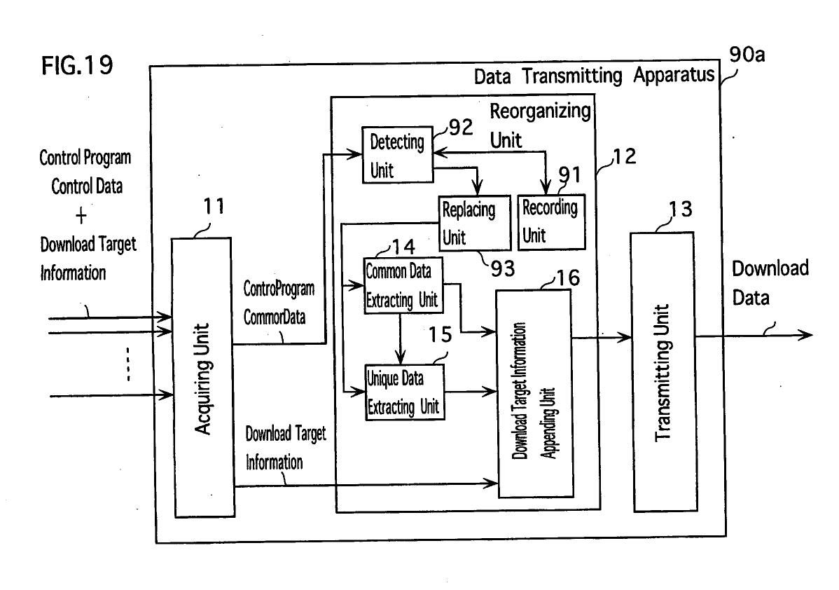

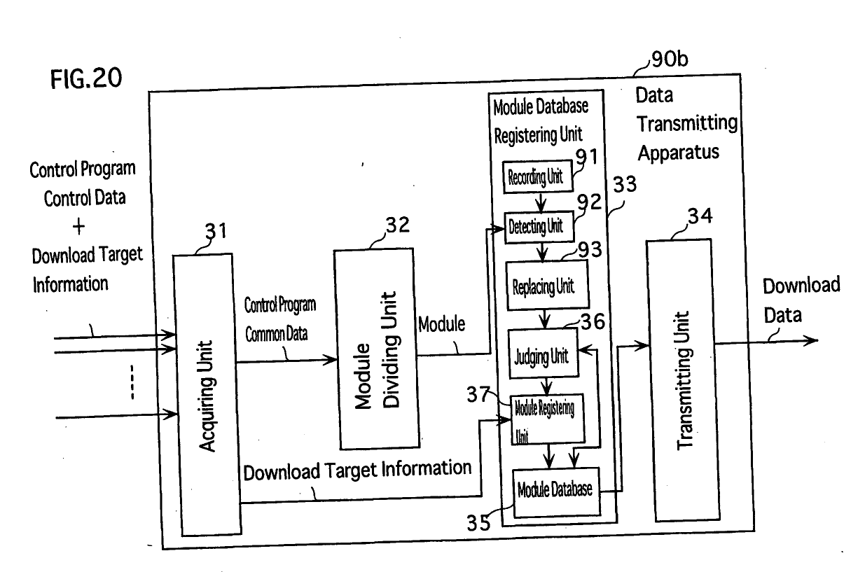

FIGS. 19 and 20 are schematic views each showing a data transmitting apparatus consistent with the embodiment 5 of the present invention.

The data transmitting apparatus 90a shown in FIG. 19 is based on the data transmitting apparatus 10 of the embodiment 1 in the case of performing module-by-module basis processing, the data transmitting apparatus 50a of the embodiment 3, or the data transmitting apparatus 70a of the embodiment 4, but differs in that the reorganizing unit 12 additionally comprises a recording unit 91, which previously records data of a previous version, a detecting unit 92, which detects a module having the same substance as the previous version, and a replacing unit 93, which replace the substance of a detected module with a copy command. The other components are the same as those of the data transmitting apparatus 10 of the embodiment 1, the data transmitting apparatus 50a of the embodiment 3 or the data transmitting apparatus 70a of the embodiment 4, and thus description thereof is omitted.

The data transmitting apparatus 90b is based on the data transmitting apparatus 30 of the embodiment 2, the data transmitting apparatus 50b of the embodiment 3 or the data transmitting apparatus 70b of the embodiment 4, but differs in that the module database registering unit 33 additionally comprises the recording unit 91, the detecting unit 92, and the replacing unit 93. The other components are the same as those of the data transmitting apparatus 30 of the embodiment 2, the data transmitting apparatus 50b of the embodiment 3 or the data transmitting apparatus 70b of the embodiment 4, and thus description thereof is omitted.

The recording unit 91 previously stores a previous version of download data for each model.

The detecting unit 92 compares each set of download data acquired by the respective acquiring unit with the previous version of download data for the same model on a module-by-module basis so as to detect a module having the same substance as the previous version.

The replacing unit 93 replaces the substance of the module detected by the detecting unit 92 with a copy command that instructs the data receiving apparatus to use the module of the previous version instead of the current module itself.

<Construction of Data Receiving Apparatus>

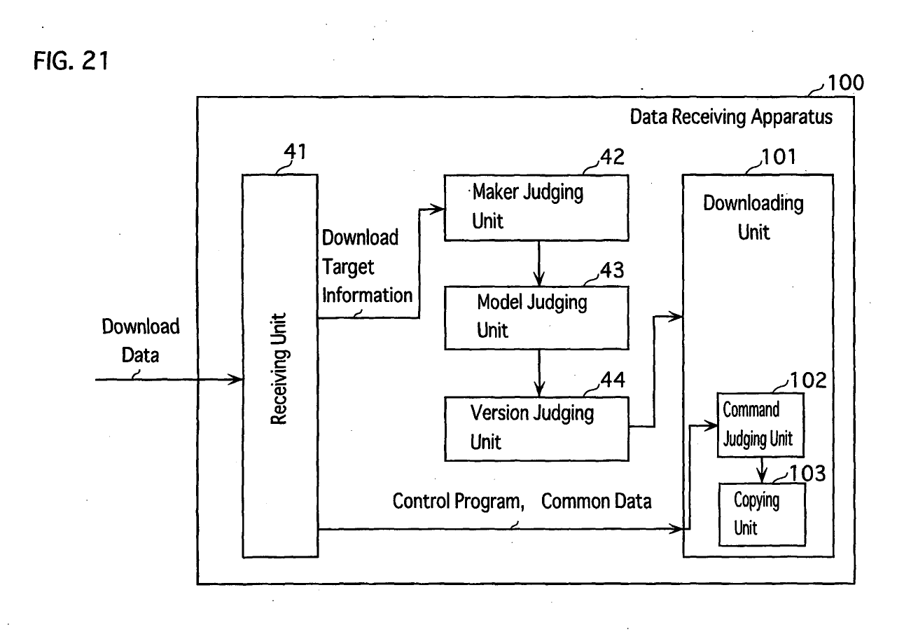

FIG. 21 is a schematic view showing a data receiving apparatus consistent with the embodiment 5 of the present invention.

The data receiving apparatus 100 shown in FIG. 21 is based on the data receiving apparatus 40 of the embodiment 2, the data receiving apparatus 60 of the embodiment 3, or the data receiving apparatus 80 of the embodiment 4, but differs in that the downloading unit 45, 61, or 81 is replaced with a downloading unit 101, which has a function of copy command processing in addition to the original functions. The other components are the same as those of the data receiving apparatus 40, 60, and 80 of the embodiment 2, 3, or 4, respectively, and thus description thereof is omitted.

The downloading unit 101 is constituted by adding a command judging unit 102 and a copying unit 103 to the downloading unit 45, 61, or 81.

When the version judging unit 44 judges that the current module is targeted for the data receiving apparatus itself and a desired version, the command judging unit 102 judges whether the substance of the current module is not the actual module itself but a copy command instructing to use the module of the previous version.

When the command judging unit 102 judges that the module is a copy command, the copying unit 103 assumes, without changing the substance, the module of the data previously stored in the flash ROM that corresponds to the module judged to be a command is overwritten with the desired version.

<Data Transmission Procedure>

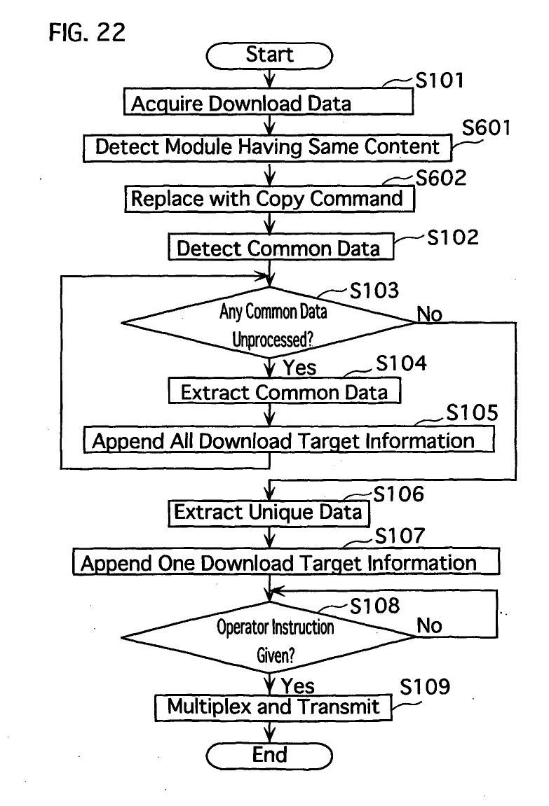

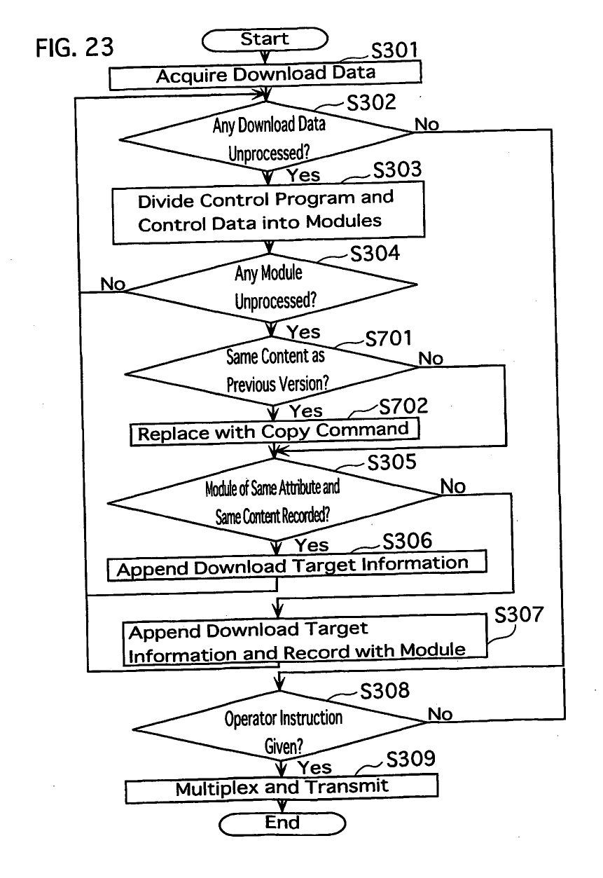

FIGS. 22 and 23 are views each showing the flow of data transmission performed by the data transmitting apparatus consistent with the embodiment 5 of the present invention.

Hereinafter, the data transmission procedure of this embodiment is described with reference to FIG. 22. Here, the same steps as those of the embodiment 1 shown in FIG. 3 are denoted by the same step numbers.

(1) The acquiring unit 11 acquires a plurality of sets of download data, each of which is targeted for one model (step S101).

(2) The detecting unit 92 compares the download data for that is acquired by the acquiring unit with the previous version of download data that is stored by the recording unit 91 on a module-by-module basis so as to detect a module having the same substance (step S601).

(3) If a module having the same substance is detected in the previous version, the replacing unit 93 replaces the substance of the current module with a copy command that instructs the data receiving apparatus to use the module of the previous version instead of the current module itself (step S602).

(4) The common data extracting unit 14 makes model-by-model comparisons among the sets of download data acquired by the acquiring unit 11 so as to detect common data that is common among two or more models (step S102).

(5) The common data extracting unit 14 judges whether there is any other common data left unprocessed (step S103).

(6) The common data extracting unit 14 extracts the unprocessed common data, if any (step S104).

(7) The download target information appending unit 16 appends, to each set of extracted common data, all the pieces of download target information of the download data that includes the common data (step S105).

Here, in the case of following the embodiment 4, the CA information appending unit 71 adds, to each module or to each piece of download target information appended to each module, CA information that is appended to the original module.

(8) When there is no more common data left unprocessed, the unique data extracting unit 15 extracts unique data from each set of download data acquired by the acquiring unit 11 by excluding, from each-set, all the common data extracted by the common data extracting unit 14 (step S106).

(9) The download target information appending unit 16 appends, to each set of extracted unique data, one piece of download data information of corresponding download data (step S107).

Here, in the case of following the embodiment 4, the CA information appending unit 71 adds, to each module or to each piece of download target information appended to each module, CA information that is appended to the original module.

(10) The data transmitting apparatus waits until the operator instructs to transmit download data (step S108).

(11) Upon receiving an operator's instruction to transmit download data, the transmitting unit 13 packetizes the download data targeted for plurality of models. The download data is composed of sets of common data, each of which is appended with a plurality of pieces of identification information, and sets of common data, each of which is appended with one piece of identification information. Then, the transmitting unit 13 multiplexes the resulting packets into one modulated wave to transmit (step S109).

Here, in the case of following the embodiment 3, the transmission sequence determining unit 51 determines the transmission sequence in a manner to consecutively transmit modules in different sets of download data as long as the attribute is the same.

Hereinafter, the data transmission procedure of this embodiment is described with reference to FIG. 23. Here, the same steps as those of the embodiment 2 shown in FIG. 7 are denoted by the same step numbers.

(1) The acquiring unit 31 acquires a plurality of sets of download data, each of which is targeted for one model (step S301).

(2) The acquiring unit 31 judges whether there is any download data left unprocessed (step S302). When all the sets of download data for all the models have been processed, the processing goes into standby and waits for an operator to instruct transmission.

(3) When it is judged that there is any download data left unprocessed, the module dividing unit 32 starts processing with any set of unprocessed download data. To begin with, the module dividing unit 32 divides the control program and the data in the current set of download data into modules (step S303).

(4) Then, the module dividing unit 32 judges whether there is any module left unprocessed (step S304). When all the modules for one model have been processed, processing of download data for another model is then stated.

(5) The module database registering unit 33 starts processing with any unprocessed module. To begin with, the detecting unit 92 judges the current module has the same substance as the module with the same attribute in the download data of the previous version (step S701).

(6) When it is judged that the substance is the same, the replacing unit 93 replaces the current module with a copy command (step S702).

(7) The judging unit 36 judges whether there is a module, in the module database 35, having the same attribute and the substance as the current module (step S305).

(8) When there is a module having the same attribute and the substance, the module registering unit 37 adds the download target information of the download data being processed to the module of the same substance that is recorded in the module database 35 (step S306).

Here, in the case of following the embodiment 4, the CA information appending unit 71 adds, to each module or to each piece of download target information appended to each module, CA information that is appended to the original module.

(9) When there is no module having the same attribute, or when there is merely a module having the same attribute but the different substance, the module registering unit 37 records the current module after appending the download target information of the download data being processed (step S307).

Here, in the case of following the embodiment 4, the CA information appending unit 71 adds, to each module or to each piece of download target information appended to each module, CA information that is appended to the original module.

(10) When there is no module left unprocessed, the data receiving apparatus waits for the operator to instruct transmission (step S308).

(11) Upon receiving an operator's instruction to transmit the download data, the data transmitting unit 34 packetizes all the download data, or equivalently, all the modules recorded in the module database 35, multiplexes the resulting packets into one modulated wave to transmit (step S309).

Here, in the case of following the embodiment 3, the transmission sequence determining unit 51 determines the transmission sequence in a manner to consecutively transmit modules in different sets of download data as long as the attribute is the same.

<Download Procedure>

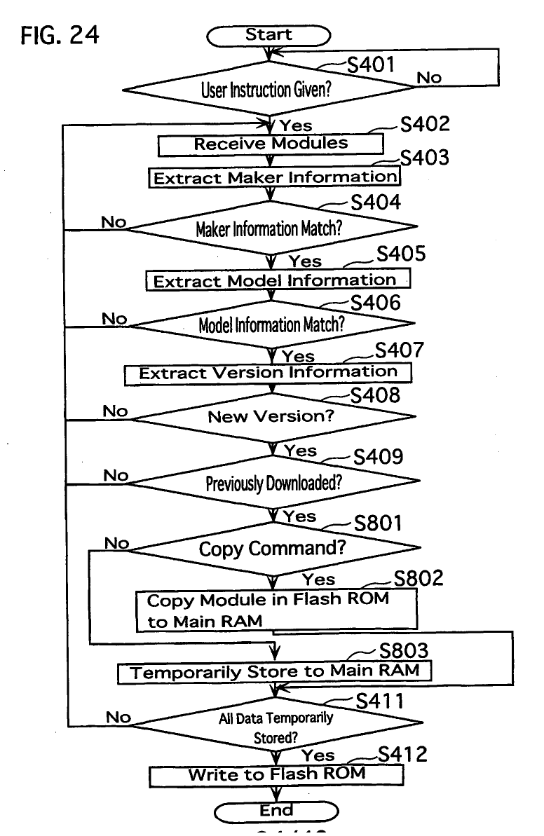

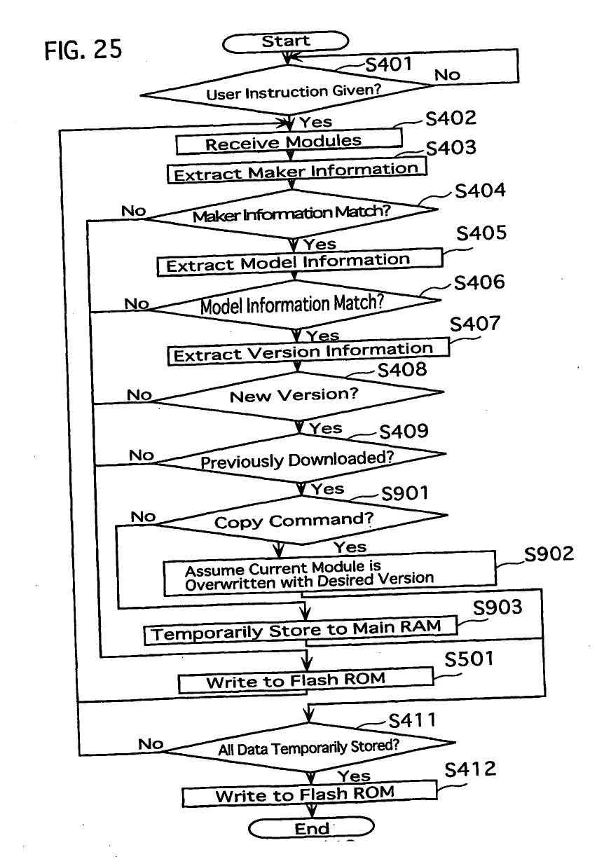

FIGS. 24 and 25 are views each showing the flow of download procedure performed by the data receiving apparatus consistent with the embodiment 5.

Hereinafter, the download procedure is described with reference to FIG. 24. Here, the same steps as those of the embodiment 2 shown in FIG. 8 are denoted by the same step numbers.

(1) The data receiving apparatus waits for a user to instruct to start downloading (step S401).

(2) Upon receiving an user's instruction to start downloading, the receiving unit 41 receives one module included in the download data transmitted from the data transmitting apparatus 30 (step S402).

(3) The maker judging unit 42 extracts maker information from the download target information appended to the received module (step S403).

(4) The maker judging unit 42 judges whether the extracted maker information matches the stored information (step S404).

(5) When it is judged that the maker information matches, the model judging unit 43 extracts model information from the download target information appended to the module being processed (step S405).

(6) The model judging unit 43 judges whether the extracted models information and the stored models information match (step S406).

(7) When it is judged that the model information matches, the version judging unit 44 extracts version information from the download target information appended to the module being processed (step S407).

(8) The version judging unit 44 judges whether the extracted information indicates a newer version than the one indicated by the stored version information (step S408).

(9) When it is judged to be a newer version, the downloading unit further judges the module being processed has been downloaded previously (step S409).

(10) When it is judged that the current module has not been downloaded yet, the command judging unit 102 judges whether the substance of the module is a copy command (step S801).

(11) When it is judge to be a copy command, the copying unit 103 copies, from the data stored in the flash ROM, a module having the same attribute as that of the current module, whereby the module of the previous version is temporarily stored in the main RAM (step S802).

(12) When it is judged that the substance of the current module is not a copy command, the downloading unit temporarily stores the current module itself in the main RAM (step S803).

(13) The downloading unit judges whether all the modules constituting the download data have been temporarily stored (step S411).

(14) When all the modules necessary for the data receiving apparatus 40 itself have been temporarily stored, the downloading unit writes the download data stored in the main RAM to the flash ROM (step S412).

Hereinafter, the download procedure is described with reference to FIG. 25. Here, the same steps as those of the embodiment 3 shown in FIG. 12 are denoted by the same step numbers.

(1) The data receiving apparatus waits for a user to instruct to start downloading (step S401).

(2) Upon receiving an user's instruction to start downloading, the receiving unit 41 receives one module included in the download data transmitted from the data transmitting apparatus 30 (step S402).

(3) The maker judging unit 42 extracts maker information from the download target information appended to the received module (step S403).

(4) The maker judging unit 42 judges whether the extracted maker information matches the stored information (step S404).

(5) When it is judged that the maker information matches, the model judging unit 43 extracts model information from the download target information appended to the module being processed (step S405).

(6) The model judging unit 43 judges whether the extracted models information and the stored models information match (step S406).

(7) When it is judged that the model information matches, the version judging unit 44 extracts version information from the download target information appended to the module being processed (step S407).

(8) The version judging unit 44 judges whether the extracted information indicates a newer version than the one indicated by the stored version information (step S408).

(9) When it is judged to be a newer version, the downloading unit further judges the module being processed has been downloaded previously (step S409).

(10) When it is judged that the current module has not been downloaded yet, the command judging unit 102 judges whether the substance of the module is a copy command (step S901).

(11) When it is judge to be a copy command, the copying unit 103 assumes a module that is stored in the flash ROM and has the same attribute as that of the current module is overwritten with the desired version without changing the substance (step S902). Here, the current module is not stored in the main RAM.

(12) When it is judged that the substance of the current module is not a copy command, the downloading unit temporarily stores the module in the main RAM (step S903).

(13) The downloading unit overwrites the module stored in the flash ROM with the module temporarily stored in the main RAM, thereby erasing the temporarily stored module (step S501).

(14) The downloading unit judges whether all the modules constituting the download data have been temporarily stored (step S411).

(15) When all the modules necessary for the data receiving apparatus 40 itself have been temporarily stored, the downloading unit writes the download data in the main RAM to the flash ROM (step S412).

The data receiving apparatus may comprise a flash ROM with an enough storage capacity, so that new download data is written to the flash ROM in areas that are not in use, followed by switching of the areas in use. In such a case, when the module is a copy command, the corresponding module in the flash ROM is copied to the write areas within the flush ROM.

<Conclusion>

As described above, according to the embodiment 5 of the present invention, each module that is the same as the previous version is replaced with a copy command. In so doing, the total amount of download data for various models is reduced.

(Modifications)

In the above embodiments of the present invention, a plurality of sets of download data for plurality of models is transmitted at a time. Yet, the present invention is equally applicable to the case where a plurality versions of download data for one and the same model are transmitted at a time, as well as to the case where a plurality of versions of download data for various models are transmitted at a time.

Further, in the case of transmitting a plurality of versions of download data at a time, a plurality of versions may be transmitted for one model. Therefore, each data receiving apparatus of the present invention may further comprise a presentation unit (not illustrated), which presents version information about available versions for the data receiving apparatus itself, and an accepting unit (not illustrated), which accepts a user-input designating a desired version decided by the user with reference to the presented version information. In this case, the version judging unit 24 of the embodiment 1 or 3, or the version judging unit 44 of the embodiment 2 or 3 does not judge whether the current download data is a new version, but judges whether the current download data is the desired version accepted by the accepting unit.

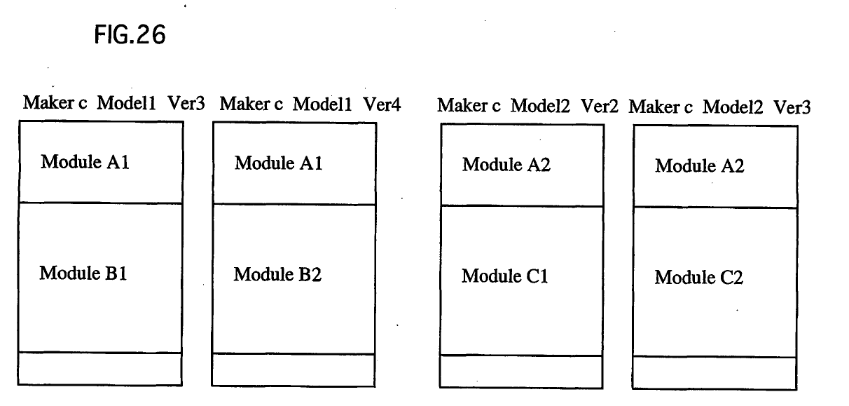

FIG. 26 is a view showing module structures of two versions of download data for model 1 and another two versions of download data for model 2. Here, each alphabetic character represents the attribute of the module, and each numeric character following the alphabetic character represents the version of the module. Accordingly, the modules with the same alphabetic character and different numeric characters have the same attribute but different substance, while the modules with the same alphabetic character and numeric character have the same version and substance. Further, the numeric characters preceded by the letters., “Ver” represent the version numbers of each download data.

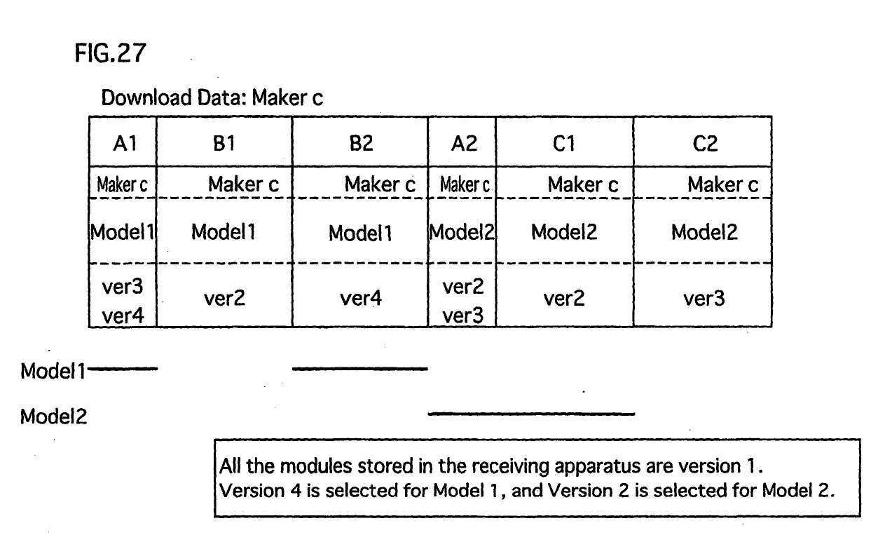

FIG. 27 is a view showing the transmission sequence when each module shown in FIG. 26 is transmitted in the sequence of the models 1 and then 2.

### EMBODIMENT 6

<Overview>

In an embodiment 6 of the present invention, a data transmitting apparatus consistent with the embodiment 2, 3, 4, or 5 appends information data, such as explanations relating to function-upgrade that will be realized after downloading, to each module constituting download data, so that the download data is broadcasted together with the information data. A data receiving apparatus consistent with the embodiment 2, 3, 4, or 5 receives the said information data and presents it to the user.

<Construction of Data Transmitting Apparatus>

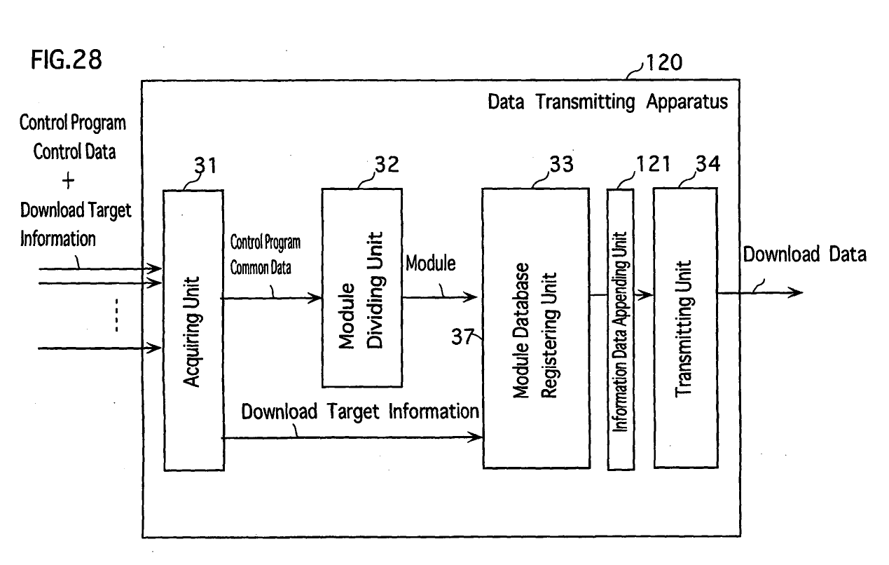

FIG. 28 is a schematic view showing a data transmitting apparatus consistent with the embodiment 6 of the present invention.

The data transmitting apparatus 120 shown in FIG. 28 comprises the acquiring unit 31, the module dividing unit 32, the module database registering unit 33, an information data appending unit 121, and the transmitting unit 34.

The data transmitting apparatus 120 is based on the data transmitting apparatus 30, 50b, 70b, or 90b of the embodiment 2, 3, 4, or 5, respectively, but differs in that the information data appending unit 121 is additionally incorporated between the module database registering unit 33 and the transmitting unit 34. Thus, description of the other components is omitted.

The information data appending unit 121 appends information data, such as function-upgrade for each model or module, to each module of the corresponding model or to each corresponding module. Here, information data is, for example, mail data or bitmap data.

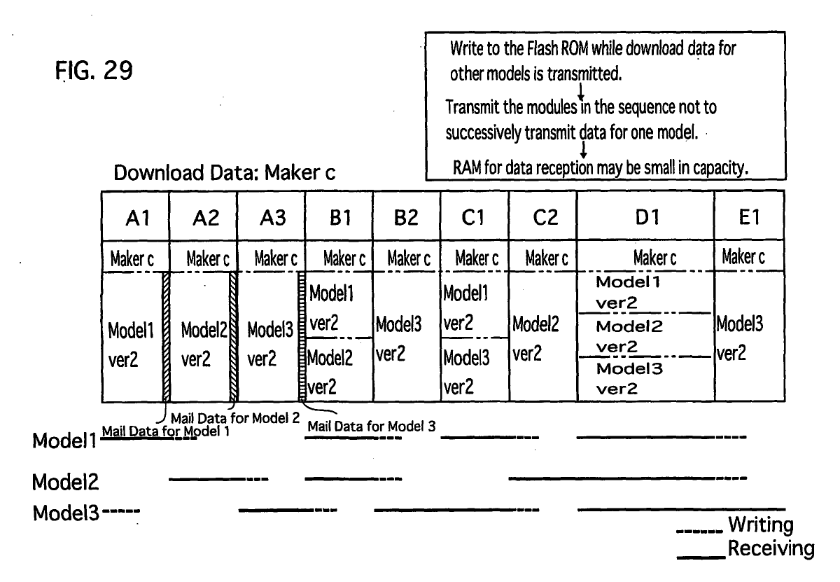

FIG. 29 is a view showing the transmission sequence in the case of appending mail data about function-upgrade for one model to each module of the corresponding model.

As shown in FIG. 29, mail data for model 1 is appended to the module A1, mail data for model 2 is appended to the module A2, and mail data for model 3 is appended to the module A3.

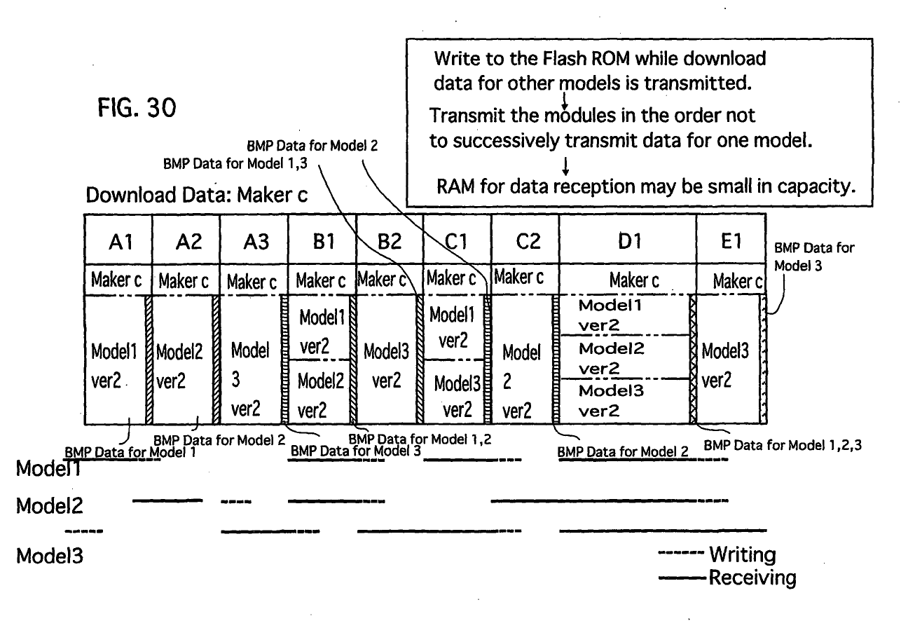

FIG. 30 is a view showing the transmission sequence in the case of appending bitmap data about function-upgrade for one module to each corresponding module.

As shown in FIG. 30, each module is appended with corresponding bitmap data.

<Construction of Data Receiving Apparatus>

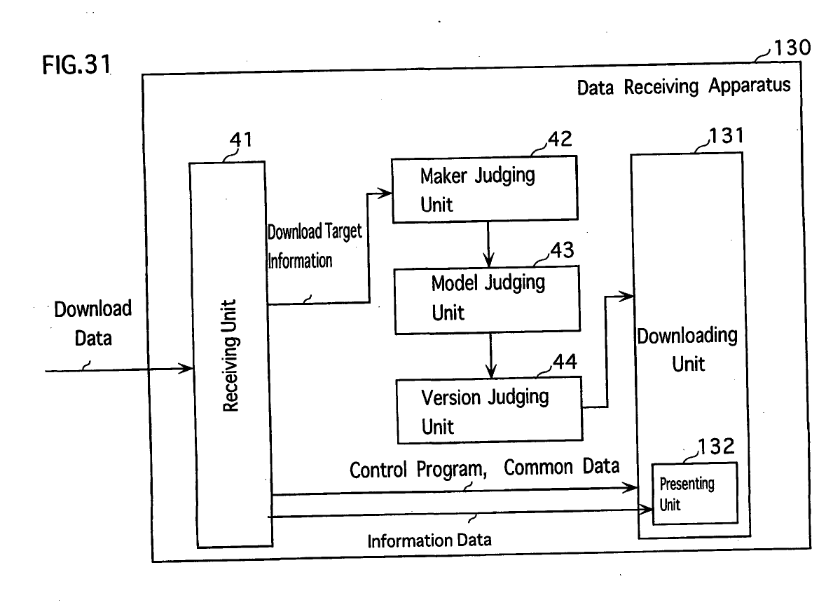

FIG. 31 is a schematic view showing a data receiving apparatus consistent with the embodiment 6 of the present invention.

The data receiving apparatus 130 shown in FIG. 31 is based on the data receiving apparatus 40, 60, 80, or 100 of the embodiment 2, 3, 4, or 5 respectively, but differs in that each downloading unit 45, 61, 81, and 101 is replaced with a downloading unit 131, which has a function of processing each type of information data in addition to the original functions. The other components are the same as those of the data receiving apparatus 40, 60, 80 or 100 respectively of the embodiment 2, 3, 4, or 5, thus description thereof is omitted.

The downloading unit 131 is constituted by further adding a presenting unit 132 to the downloading unit 45, 61, 81, or 101.

The presenting unit 132 receives information data from the data receiving unit 41 and displays the information on a display device. Here, when receiving mail data, the data receiving unit 41 automatically displays the information mail successively or after downloading. When receiving bitmap data, the data receiving unit 41 successively writes the bitmap data directly to pictorial area in display memory, so that information is displayed in forms of bitmap images on the display device while download continues.

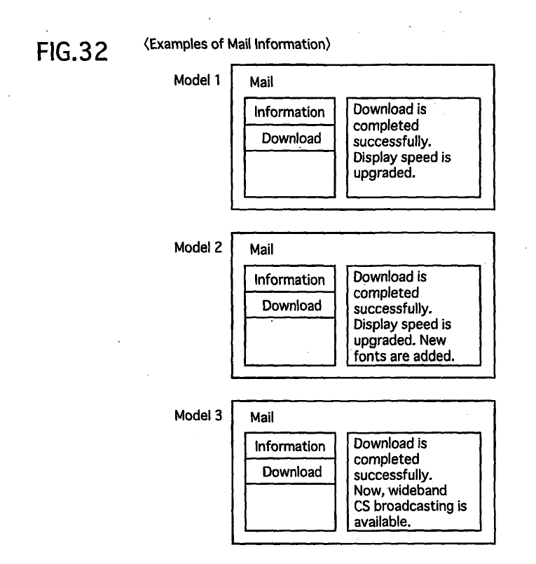

FIG. 32 is a view showing examples of mail data display, which provides information to the user.

For example, when mail data is received through download, the information of mail data is automatically displayed when download is completed. Alternatively, indication, such as a mark, may be displayed to notify the user that there is an information mail received, so that the user conducts operations, such as a click on the mark, to open the mail, whereby the information mail is displayed.

As shown in FIG. 32, information mail corresponding to each model is displayed with a list of the titles displayed on the left and the message of a selected mail displayed on the right.

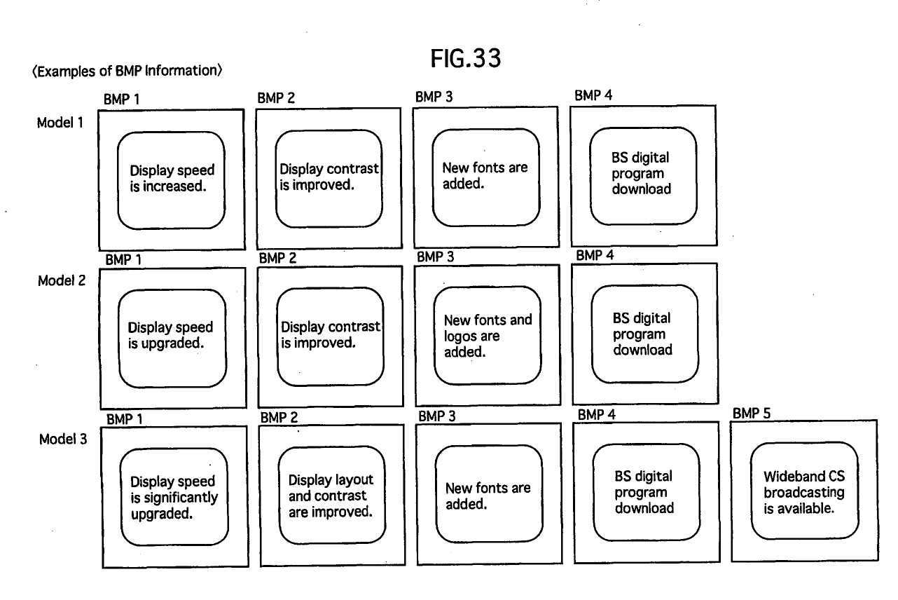

FIG. 33 is a view showing examples of bitmap data display, which provides information to the user.

For example, when bitmap data is received through download, the information represented by the bitmap data is successively displayed.

As shown in FIG. 33, bitmap data corresponding to the module being downloaded is displayed. Here, modules having the common control program also have common bitmap data. Further, since the sequence of modules to be downloaded is not specified, the sequence of bitmap data to be displayed is not specified, either.

<Data Transmission Procedure>

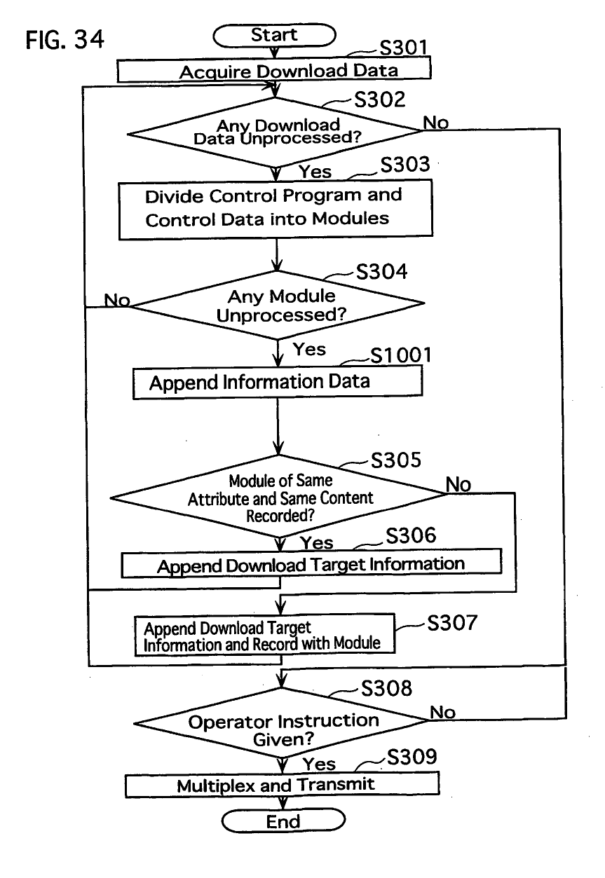

FIG. 34 is a view showing the flow of data transmission procedure performed by the data transmitting apparatus consistent with the embodiment 6 of the present invention.

The data transmission procedure of this embodiment shown in FIG. 34 is the same as that of the embodiment 2 (see FIG. 7), but differs in that the following additional step is performed after the judgment in the step S304 results in “Yes” but before the step S305. In that additional step, the information data appending unit 121 appends, to each module, corresponding information data about function-upgrade (step S1001).

<Download Procedure>

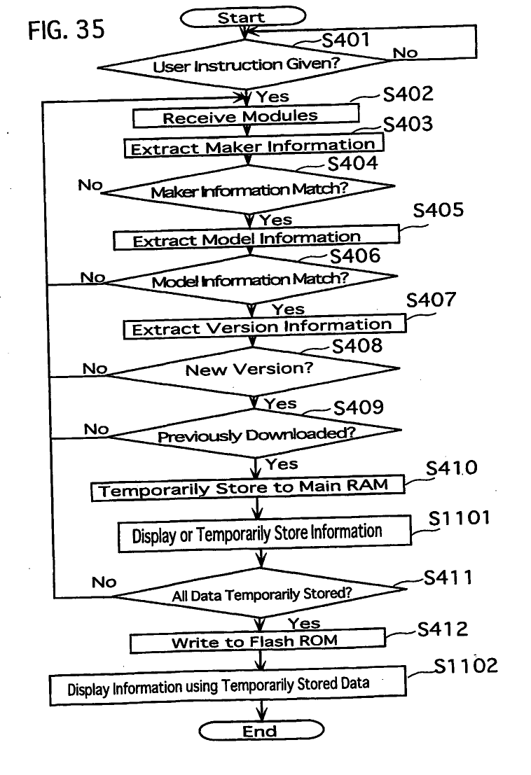

FIG. 35 is a view showing the flow of download procedure performed by the data receiving apparatus consistent with the embodiment 6 of the present invention.

The download procedure of this embodiment shown in FIG. 35 is the same as that of the embodiment 2 (see FIG. 8), but differs in that the following two additional steps are performed. After the step S410, the presenting unit 132 receives information data from the receiving unit 41 and successively displays it on a display device or temporarily stores it in the main RAM (step S1101). After the step 412, the presenting unit 132 displays information represented by the data that has been temporarily stored (step S1102).

<Conclusion>

As described above, according to the embodiment 6 of the present invention, information data is appended to each module and transmitted with the modules, whereby information that is different depending on each model is presented to a user.

### EMBODIMENT 7

<Overview>

In an embodiment 7 of the present invention, a data transmitting apparatus separates a plurality of sets of download data, each of which is targeted for one model, into the following two types: data that is common among all the models and data that is not common among all the models. Then, the data transmitting apparatus transmits the common data without encryption, and transmits unique data after encrypting with an encryption key that corresponds to each model. A data receiving apparatus downloads only data targeted for the data receiving apparatus itself and decrypts it using a decryption key that corresponds to each model.

<Construction of Data Transmitting Apparatus>

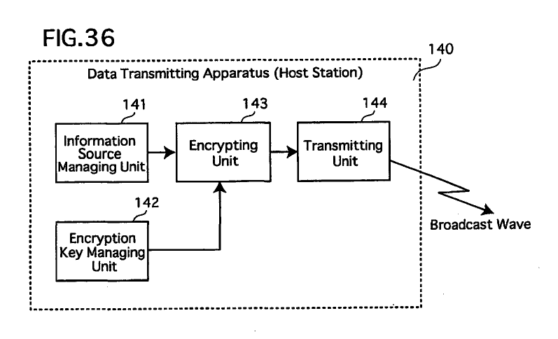

FIG. 36 is a view showing a data transmitting apparatus (host station) consistent with the embodiment 7 of the present invention.

The data transmitting apparatus 140 shown in FIG. 36 comprises an information source managing unit 141, an encryption key managing unit 142, encrypting unit 143, and a transmitting unit 144.

The information source managing unit 141 holds or externally acquires, and then manages various data, such as image data, voice data, program data, and encryption management information data.

Here, program data is composed of a plurality of program modules. One of the program modules is a core program module, which implements basic functions and is common among all the plurality of models. The remaining modules are various subprogram modules, which implement other functions and may not be common among the models.

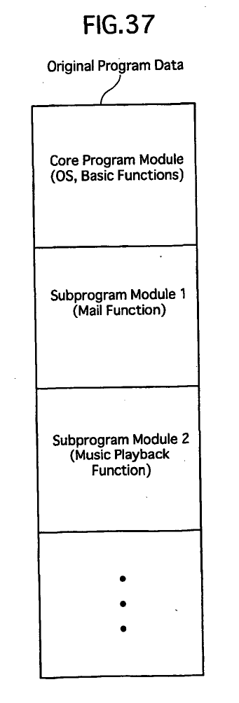

FIG. 37 is a view showing an example of a program data that the information source managing unit 141 manages.

The program data shown in FIG. 37 includes a core program module for implementing the OS (operating system) and basic functions, a subprogram module 1 for implementing a mail function, and a subprogram module 2 for implementing a music playback function.

Further, encryption management data is the data showing correlation among subprogram modules, encryption keys and decryption keys. When a single secret key is used for both encrypting and decrypting, the encryption management data is the data showing correlation between subprogram module and secret keys.

The encryption key managing unit 142 holds or externally acquires, and then manages an encryption key for each model or each subprogram module.

To encrypt each subprogram module managed by the information source managing unit 141, the encrypting unit 143 selects an encryption key from among the keys managed by the encryption key managing unit 142 with reference to the correlation shown by the encryption management data, and then encrypts each module in compliance with DES (Data Encryption Standard) or other cipher systems. In addition to subprogram modules, the encrypting unit 143 also encrypts image data and voice data managed by the information source managing unit 141. Here, two or more subprogram modules for one and the same model may be encrypted with one encryption key.

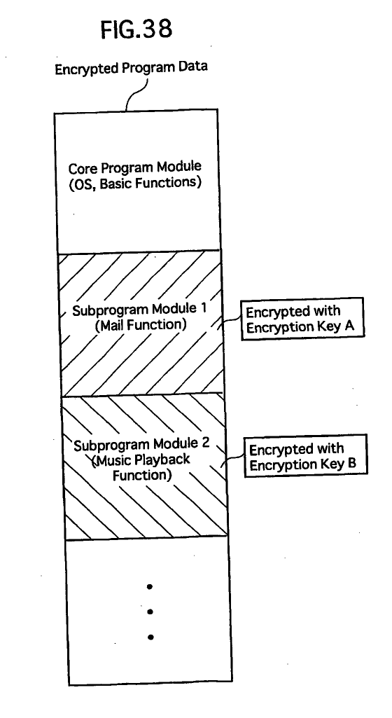

FIG. 38 is a view showing an example of program data including subprogram modules that have been encrypted by the encrypting unit 143.

In the program data shown in FIG. 38, the core program module is not encrypted, the subprogram module 1 is encrypted with an encryption key A, and the subprogram module 2 is encrypted with an encryption key B.

The transmitting unit 144 (1) packetizes and multiplexes the core program module, which is managed by the information source managing unit 141, and the subprogram modules, which are encrypted by the encrypting unit 143 together with the image data and the voice data, (2) adds error-correcting codes such as RS (Reed-Solomon) codes, (3) modulates the resulting packets using a modulation technique, such as π·4QPSK (Quadrature Phase Shift Keying), and (4) transmit the thus generated broadcast wave.

<Construction of Data Receiving Apparatus>

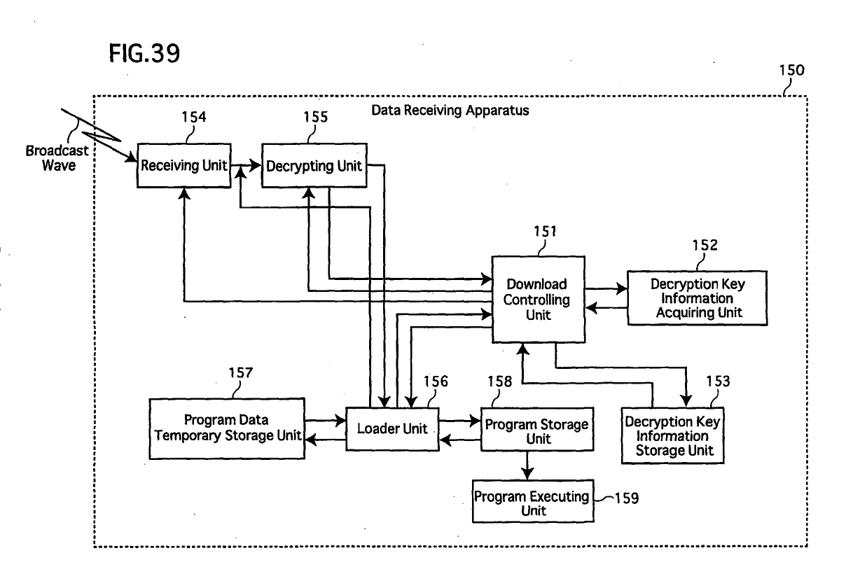

FIG. 39 is a view showing a data receiving apparatus consistent with the embodiment 7 of the present invention.

The data receiving apparatus 150 shown in FIG. 39 comprises, a download controlling unit 151, a decryption key information acquiring unit 152, a decryption key information storage unit 153, a receiving unit 154, decrypting unit 155, a loader unit 156, a program data temporally storage unit 157, a program storage unit 158, and a program executing unit 159.

The download controlling unit 151 controls the receiving unit 154 and the decrypting unit 155, thereby controlling the download processing, and also controls the decryption key information acquiring unit 152 and the decryption key information storage unit 153, thereby controlling the decryption key acquiring processing.

The decryption key information acquiring unit 152 acquires decryption keys through a public circuit, such as a telephone circuit, or by reading from a record medium provided.

The decryption key information storage unit 153 stores decryption keys acquired by the decryption key information acquiring unit 152, or has previously stored decryption keys.

The receiving unit 154 receives and demodulates the broadcast wave modulated by using a modulation technique, such as π·4QPSK. The receiving unit 154 then performs error correction when the received data includes error-correcting codes such as RS codes, and separates the data into program data, image data and voice data.

Here, the receiving unit 154 receives and separates program data as shown in FIG. 38.

From among encrypted subprogram modules included in the program data separated by the receiving unit 154, the decrypting unit 155 decrypts only the modules that are decryptable with the keys stored in the decryption key information storage unit 153.

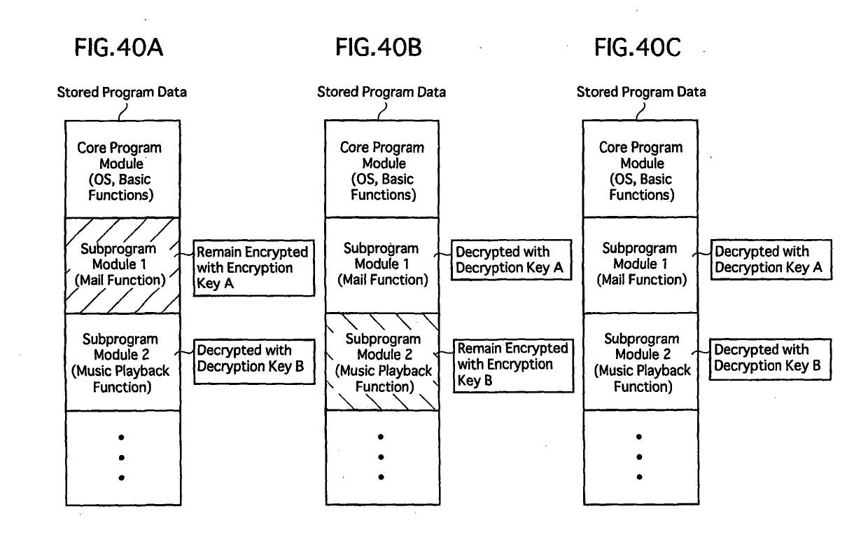

FIGS. 40A, 40B and 40C are views showing examples of program data, which include subprogram modules decrypted by the decrypting unit 155.

Here, the subprogram module that has been encrypted with the encryption key A is decryptable with the decryption key A, while the subprogram that has been encrypted with the encryption key B is decryptable with the decryption key B.

The program data shown in FIG. 40A is in the state stored in the program storage unit 158 in the case where the decryption key information storage unit 153 stores the decryption key B but not the decryption key A. The core program module is never encrypted. The subprogram module 1 is not decrypted and thus remains encrypted with the encryption key A. The subprogram module 2 is decrypted by the decrypting unit 155 with the decryption key B.

The program data shown in FIG. 40B is in the state stored in the program storage unit 158 in the case where the decryption key information storage unit 153 stores the decryption key A but not the decryption key B. The core program module is never encrypted. The subprogram module 1 is decrypted by the decrypting unit 155 with the decryption key A. The subprogram module 2 is not decrypted and thus remains encrypted with the encryption key B.

The program data shown in FIG. 40C is in a state stored in the program storage unit 158 in the case where the decryption key information storage unit 153 stores both the decryption key A and the decryption key B. The core program module is never encrypted. The subprogram module 1 is decrypted with the decryption key A, and the subprogram module 2 is decrypted with the decryption key B respectively by the decrypting unit 155.

The loader unit 156 is used to transmit program data mutually among the download controlling unit 151, the decrypting unit 155, the program data temporary storage unit 157, and the program storage unit 158.

The program data temporary storage unit 157 temporarily stores program data on a module-by-module basis at the time of download processing.

The program storage unit 158 may be nonvolatile memory, such as flash ROM, and stores programs to be executed by the program executing unit 159. At the time of download processing, the program data that is temporarily stored in the program data temporary storage unit 157 is stored in the program storage unit 158.

The program executing unit 159 may comprise a CPU, work memory, and the like, and reads out and executes the program stored in the program storage unit 158.

<Data Transmission Procedure>

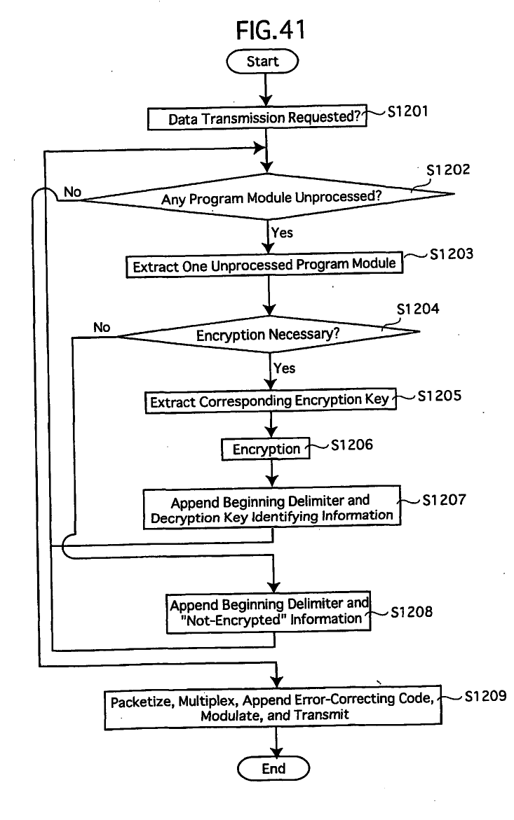

FIG. 41 is a view showing the flow of data transmission performed by the data transmitting apparatus consistent with the embodiment 7 of the present invention.

Hereinafter, the data transmission procedure is described with reference to FIG. 41.

(1) Data transmission is requested (step S1201).

(2) The encryption unit 143 judges whether there is any program module left unprocessed (step S1202).

(3) When there is a module unprocessed, the encrypting unit 143 extracts one of the unprocessed modules from the program data managed by the information source managing unit 141. The extracted module is subjected to the following processing. (step S1203)

(4) With reference to the correlation shown by the encryption management information data, the encrypting unit 143 judges whether the subject module needs to be encrypted (step S1204).

(5) When it is judged that the subject module needs to be encrypted, the encrypting unit 143 extracts a corresponding encryption key from the encryption key managing unit 142 with reference to the correlation shown by the encryption management information (step S1205).

(6) The encrypting unit 143 encrypts the subject program module with the extracted key (step S1206).

(7) The encrypting unit 143 appends, to the beginning of the subject module, a delimiter for indicating the beginning of the module and information for identifying the corresponding decryption key (step S1207). Then, the procedure returns to the steps for processing another unprocessed module.

(8) When it is judged that encryption is unnecessary, the encrypting unit 143 appends, to the beginning of the subject module, a delimiter for indicating the beginning of the module and information for indicating that the module is not encrypted (step S1208).

(9) When there is no program modules left unprocessed, the transmitting unit 144 packetizes and multiplexes the core program module, which is managed by the information source managing unit 141, and the subprogram modules, which are encrypted by the encrypting unit 143 together with the image data and the voice data, adds error-correcting codes, and then modulates the resulting packets to transmit (step S1209).

Here, program modules, if required, are encrypted on a module-by-module basis and then packetized. Alternatively, however, the program modules may be packetized first and then encrypted on a packet-by-packet basis.

<Download Procedure>

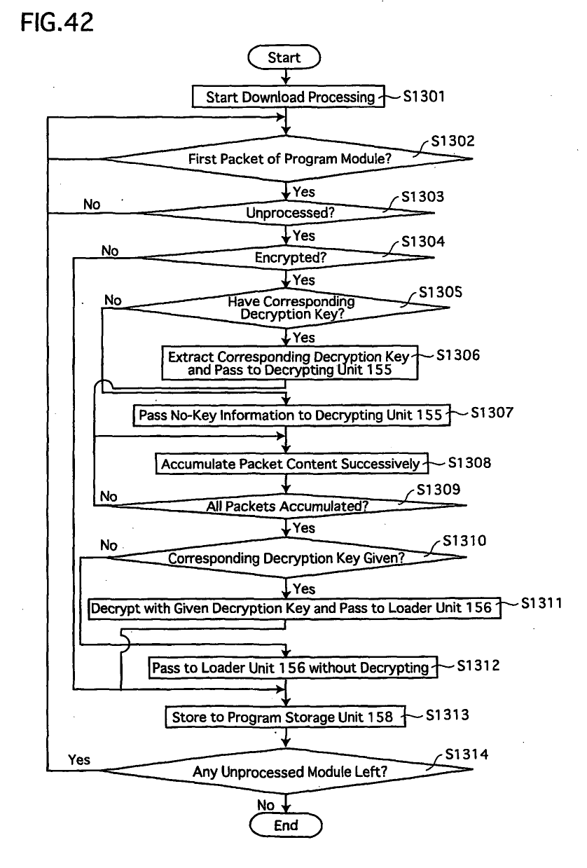

FIG. 42 is a view showing the flow of download procedure performed by the data receiving apparatus consistent with the embodiment 7 of the present invention.

Hereinafter, the download procedure is described in outline with reference to FIG. 42.

(1) Triggered by a pre-announced time at which program data is scheduled to be broadcasted or by a user-request, the download controlling unit 151 exerts control over the receiving unit 151, the receiving unit 154, and the decrypting unit 155, thereby starting download processing (step S1301).

(2) The download controlling unit 151 judges whether the packet received by the receiving unit 154 is the first packet of any program modules constituting the program data (step S1302).

Here, for example, whether the packet is the first packet of each program module may be judged using the information appended at the beginning of each module.

(3) When the received packet is the first packet of a program module, the download controlling unit 151 judges whether the current program module has not been processed yet (step S1303). When the program module has been processed, the procedure returns to the step S1302 to judge whether a packet received next is the first packet of any module.

(4) When the packet has not been processed, the download controlling unit 151 designates the program module as the program module subjected to the processing and then judges whether the subject program module is encrypted (step S1304). When the subject program module is not encrypted, the processing goes on to the step of accumulating the subject program module to the program data temporary storage unit 157 (step S1308).

Here, for example, whether the subject program module is encrypted may be judged using the information appended at the beginning of each module.

(5) When the subject program module is encrypted, the download controlling unit 151 judges whether the decryption key information storage unit 153 has a corresponding decryption key (step S1305).

(6) When a corresponding decryption key is found, the download controlling unit 151 extracts the corresponding key and passes it to the decrypting unit 155 (step S1306).

(7) When a corresponding key is not found, the download controlling unit 151 passes “no-key” information to decrypting unit 155 so as to notify that there is no corresponding decryption key (step S1307).

(8) The download control unit 151 successively accumulates, in the program data temporally storage unit 157, the packets constituting the subject program module received by the receiving unit 154 (step S1308).

(9) The download control unit 151 judges whether all the packets constituting the subject module have been accumulated in the program data temporally storage unit 157 (step S1309). When all the packets have not yet stored, the processing returns to the step of accumulating the packets in the program data temporally storage unit 157 (step S1308), and the above steps are repeated until all the packets constituting the subject program module have been accumulated.

Here, for example, specific data may be previously embedded at the end of each module to indicate the end of the module, so that the last packet is recognized through receipt of the specific data.

(10) When all the packets constituting the subject program module have been accumulated in the program data temporally storage unit 157, the decrypting unit 155 judges whether the decryption key corresponding to the subject program module has been given (step S1310).

(11) When the corresponding decryption key has been given, the decrypting unit 155 decrypts the accumulated program module with that decryption key (step S1311).

(12) When the corresponding decryption key has not been given, the decrypting unit 155 passes the accumulated program modules to the loader unit 156 without decrypting (step S1312).

(13) The download controlling unit 151 instructs the loader unit 156 to store the received program module in the program storage unit 158 (step S1313).

(14) The download controlling unit 151 judges whether there is any program module left unprocessed (step S1314). When there is any program module left unprocessed, the processing returns to the step S1302 to begin processing another unprocessed module. When there is no more program module left unprocessed, the download controlling unit 151 terminates the download processing.

In the case where the data transmitting apparatus packetizes program modules first and thus decryption is performed on a packet-by-packet basis, the download controlling unit 151 first decrypts each packet constituting the subject module received by the receiving unit 154, and then successively accumulates the decrypted packets in the program data temporary storage unit 157.

Further, in the above description, program data is first accumulated in the program data temporary storage unit 157 on a module-by-module basis and then processed. Alternatively, however, all the program data may be accumulated in the program data temporary storage unit 157 first, and then processed later at a time. Another alternative is to store program data directly in the program storage unit 158, so that the program data temporary storage unit 157 may be omitted.

<Program Execution Procedure>

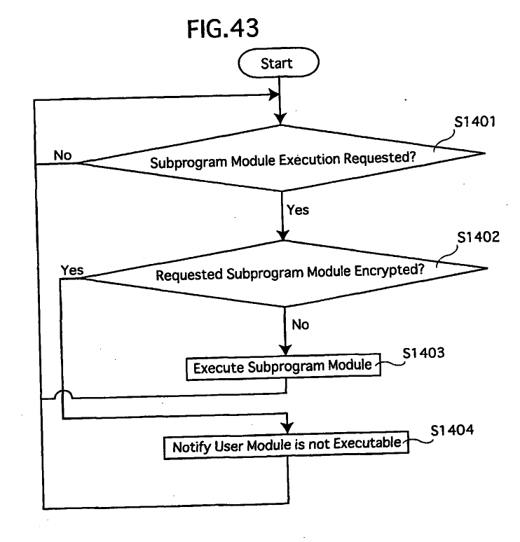

FIG. 43 is a view showing the flow of program execution procedure performed by the data receiving apparatus consistent with the embodiment 7.

Hereinafter, the program execution procedure is described in outline with reference to FIG. 43.

Here, the program storage unit 158 has the program data shown in FIG. 40A.

(1) The data receiving apparatus waits for a request to execute a subprogram module triggered in response to a user-input during the time the core program is being executed (step S1401).

(2) The program executing unit 159 finds a subprogram module that is requested to be executed from the subprogram modules stored in the program storage unit 158 to judge whether the requested module is encrypted (step S1402).

(3) If not encrypted, the program executing unit 159 executes the requested subprogram module, and then the processing returns to the core program execution (step S1403).

(4) If encrypted, the requested module is not executable. So, the program executing unit 159 notifies the user that the requested program is not executable, and then processing returns to the core program execution (step S1404).

In the above description, whether a requested subprogram module is executable is judged based on whether or not the module is encrypted. However, an alternative is to store, at the time of download, information for identifying the program modules that are not decrypted due to the absence of corresponding decryption key, so that the judgment may be made based on the information. Another alternative is to inform a user as to whether each subprogram module is executable, so that the user selects a desired subprogram module from among executable ones.

<Procedure for Decryption Key Acquiring and Decrypting>

FIG. 44 is a view showing the flow of procedure for decryption key acquiring and decrypting preformed by the data receiving apparatus consistent with the embodiment 7 of the present invention.

Described hereinafter with reference to FIG. 44 is the outline of the procedure for decryption key acquiring and decrypting performed after download.

(1) Triggered by a user-request, the decryption key information acquiring unit 152 acquires a new decryption key (step S1501).

(2) The decryption key information acquiring unit 152 stores the new decryption key in the decryption key information storage unit 153 (step S1502).

(3) The download controlling unit 151 judges whether there is any subprogram module stored in the program storage unit 158 that remains encrypted and is decryptable with the new decryption key (step S1503). When there is no subprogram module decryptable with the new decryption key, the processing is terminated.

(4) When there are subprogram modules decryptable, the download controlling unit 151 passes one of the decryptable modules from the program storage unit 158 to the loader unit 156, so that the passed module is subjected to decryption (step S1504).

(5) The download controlling unit 151 instructs the loader unit 156 to store the subject module, which is passed from the program storage unit 158, in the program data temporary storage unit 157 (step S1505).

(6) The download controlling unit 151 instructs to decrypting unit 155 to decrypt the subject module, which is stored in the program data temporary storage unit 157, with the new decryption key, and then to pass the resulting decrypted program module to the loader unit 156 (step S1506).

(7) The download controlling unit 151 instructs the loader unit 156 to replace the non-decrypted subject module, which is stored in program storage unit 158, with the decrypted subject module, which is passed from the decrypting unit 155. Then, the processing returns to the step of judging whether there is any subprogram module decryptable (step S1507).

In this embodiment, one subprogram module is stored in the program data temporary storage unit 157, and subjected to decryption, so that decryption is conducted on subprogram modules one by one. However, all the subprogram modules to be decrypted may be first stored in the program data temporary storage unit 157, and then decrypted at a time. Alternatively, decryption may be conducted directly on the subject subprogram modules that are stored in the program storage unit 158, so that the program data temporally storage unit 157 may be omitted.

<Conclusion>

As described above, according to the embodiment 7 of the present invention, only one set of common data that is common among all the models is transmitted without encrypting. On the other hand, each set of unique data is encrypted with an encryption key corresponding to each model and then transmitted. In so doing, the total amount of download data for a plurality of models is reduced. In addition, the program modules that are not decryptable at the time of download are recorded without encrypting. In so doing, the program modules remain encrypted may be decrypted later when a corresponding decryption key is acquired without going through download procedure again.

### EMBODIMENT 8

<Overview>

In the embodiment 7 of the present invention, all the program modules are accumulated regardless of whether each program module is encrypted or whether it is decryptable at the time of download. In an embodiment 8 of the present invention, however, data transmitting apparatus is constituted not to record any encrypted modules if they are not decryptable at the time of download.

<Construction of Data Transmitting Apparatus>

The data transmitting apparatus consistent with the present invention is the same as the data transmitting apparatus 140 of the embodiment 7 shown in the FIG. 36, and thus description thereof is omitted.

<Construction of Data Receiving Apparatus>

The construction of the data receiving apparatus consistent with the embodiment of the present invention is the same as the data receiving apparatus 150 of the embodiment 7 shown in FIG. 39. Thus, description thereof is omitted.

<Data Transmission Procedure>

The flow of data transmission procedure performed by the data transmitting apparatus of the embodiment 8 is the same as that of the embodiment 7 shown in FIG. 41. Thus, description thereof is omitted.

<Download Procedure>

FIG. 45 is a view showing the flow of download procedure performed by the data receiving apparatus consistent with the embodiment 8 of the present invention. The same steps as those of the embodiment 7 shown in FIG. 42 are denoted by the same step numbers.

Hereinafter, the download procedure is described in outline with reference to FIG. 45.

(1)-(6) The same steps S1301-S1306 as shown in FIG. 42 are performed.

(7) When there is no corresponding decryption key, the download controlling unit 151 terminates the processing on the current subject module, and the processing returns to the step S1314 to judge whether any program module left unprocessed (step S1601).

(8)-(14) The same steps S1308-1314 as shown in FIG. 42 are performed.

In the above description, program data is first accumulated in the program data temporary storage unit 157 on a module-by-module basis and then processed. Alternatively, however, all the program data may be accumulated in the program data temporary storage unit 157 first, and then processed later at a time. Another alternative is to store program data directly in the program storage unit 158, so that the program data temporary storage unit 157 may be omitted.

<Conclusion>

As described above, according to the embodiment 8 of the present invention, only one set of common data that is common among all the models is transmitted without encrypting. On the other hand, each set of unique data is encrypted with an encryption key corresponding to each model and then transmitted. In so doing, the total amount of download data for a plurality of models is reduced. In addition, the program modules are not recorded if they are not decryptable at the time of download, which requires only minimum program storage area.

Further, a program for implementing the operations performed in the present invention may be distributed in forms of a computer-readable storage medium storing the program, or may be subjected to commercial dealings by directly transmitting the program via a network.

The computer-readable storage medium used herein is not limited to any specific one. Instead, the computer-readable medium my be a removable recoding medium, such as a floppy disc, a compact disc, a magnet-optical disc, a DVD disc, and a memory card, or a solid-state recording medium, such as hard disk, and semiconductor memory.

Industrial Applicability

The present invention may be applicable to a set-top box, as well as to other devices, used to receive, record, and playback image data, such as television programs and live images. By applying the present invention, the total amount of download data for a plurality of models is reduced.

1. A data transmitting apparatus for transmitting data to a plurality of data receiving apparatuses, comprising:
acquiring means for acquiring a plurality of sets of selection data, each set of which is targeted for one data receiving apparatus model;
organizing means for comparing the plurality of sets of selection data and extracting common data and unique data, the common data being a portion of one set of selection data that is also contained in one or more other sets of selection data and the unique data being a remaining portion in each set of selection data left after excluding the common data; and
transmitting means for transmitting the common data and the unique data together to the plurality of data receiving apparatuses.

2. The data transmitting apparatus according to claim 1, wherein
each set of selection data is composed of a plurality of modules,
the organizing means includes
(1) common data extracting means for extracting, as the common data, a module of which substance is common among all the sets of selection data by comparing the plurality of sets of selection data module by module,
(2) unique data extracting means for extracting, as the unique data, all the modules other than the modules extracted by the common data extracting means,
(3) recording means for recording, in advance, an encryption key that corresponds to each of the modules extracted as the unique data by the unique data extracting means, and
(4) encrypting means for encrypting each of the modules extracted as the unique data using the corresponding encryption key recorded in the recording means, and
the transmitting means transmits the modules extracted as the common data by the common data extracting means and the modules encrypted by the encrypting means together to the plurality of data receiving apparatuses.

3. The data transmitting apparatus according to claim 1, wherein
the organizing means
extracts, as the common data, a portion of selection data that is common among two or more sets of selection data,
appends, to each piece of the extracted common data, all pieces of identification information relating to sets of the selection data which the piece of the common data has been extracted, and
appends, to each piece of the extracted unique data, one piece of identification information relating to one set of the selection data from which the piece of the unique data has been extracted, and
the transmitting means transmits together
each piece of the common data together with all the pieces of identification information appended thereto, and
each piece of the unique data together with the one piece of identification information appended thereto.

4. The data transmitting apparatus according to claim 3, wherein
each set of the selection data is (1) a set of data targeted for a different data receiving apparatus model, (2) a set data targeted for the same data receiving apparatus model but in a different version, or (3) a set of data targeted for a different data receiving apparatus model and in a different version, and includes at least a control program used by a target data receiving apparatus model, and
the organizing means detects the common data by comparing the plurality of sets of selection data, the comparison being conducted by model, by version, or by both model and version.

5. The data transmitting apparatus according to claim 4, wherein
the organizing means includes
(1) common data extracting means for extracting the common data,
(2) unique data extracting means for excluding the common data from each set of the selection data thereby to extract the unique data that is unique to each set of the selection data, and
(3) identification information appending means for appending, to each piece of the common data, all the pieces of identification information relating to all the sets of the selection data from which the piece of the common data has been extracted, and for appending, to each piece of the unique data, the one piece of identification information relating to the set of the selection data from which the piece of the unique data has been extracted.

6. The data transmitting apparatus according to claim 5, wherein
each set of the selection data is composed of a plurality of modules each having a different attribute,
the common data extracting means extracts, as the common data, a module of which substance is common among a plurality of sets of the selection data by comparing modules having the same attribute in different sets of the selection data, and
the unique data extracting means extracts, as the unique data, all the modules other than the modules extracted by the common data extracting means.

7. The data transmitting apparatus according to claim 6, wherein
the transmitting means includes transmission sequence determining means for determining a sequence of modules, whereby modules having the same attribute in different sets of the selection data are transmitted consecutively.

8. The data transmitting apparatus according to claim 6, wherein
each of the modules constituting each set of the selection data is appended with charge information that indicates whether a charge is to be made for the module, and
the organizing means further includes
charge information appending means for appending, to each module or to each piece of identification information at the time of appending identification information, charge information that is appended to an original module.

9. The data transmitting apparatus according to claim 6, wherein
the organizing means further includes
(1) recording means for recording, in advance, a previous version of each set of the selection data;
(2) detecting means for comparing each set of the selection data acquired by the acquiring means with a corresponding set of selection data in a previous version recorded in the recording means on a module-by-module basis so as to detect a module of which substance is common among the two sets of selection data, and
(3) replacing means for replacing the substance of the module detected by the detecting means with an instruction command that instructs the plurality of data receiving apparatuses to use the module in the previous version.

10. The data transmitting apparatus according to claim 6, wherein
the organizing means further includes information data appending means for appending, to each of the modules, information data that provides an explanation of the module.

11. The data transmitting apparatus according to claim 4, wherein
each set of the selection data is composed of a plurality of modules each having a different attribute,
the organizing means includes
(1) module recording means provided with a storage area for recording modules together with identification information appended to the modules,
(2) judging means for judging,whether each of the modules has the same attribute and the substance as any of the modules recorded in the module recording means, and
(3) module registering means for registering the plurality of modules one by one in the module recording means, whereby (i) when the judging means judges that there is no module recorded in the module recording means having the same attribute and the substance as a current module, the current module is appended with a piece of identification information about a corresponding set of the selection data and then recorded in the module recording means, and (ii) when the judging means judges that there is a module recorded in the module recording means having the same attribute and the substance as a current module, the module recorded in the module recording means is additionally appended a piece of identification information relating to a set of the selection data corresponding to the current module, and
the transmitting means transmits all the modules recorded in the module recording means after the plurality of modules are all registered.

12. The data transmitting apparatus according to claim 11, wherein
the transmitting means includes transmission sequence determining means for determining a sequence of modules, whereby modules having the same attribute in different sets of the selection data are transmitted consecutively.

13. The data transmitting apparatus according to claim 11, wherein
each of the modules constituting each set of the selection data is appended with charge information that indicates whether a charge is to be made for the module, and
the organizing means further includes
charge information appending means for appending, to each module or to each piece of identification information at the time of appending identification is information, charge information that is appended to an original module.

14. The data transmitting apparatus according to claim 11, wherein
the organizing means further includes
(1) recording means for recording, in advance, a previous version of each set of the selection data;
(2) detecting means for comparing each set of the selection data acquired by the acquiring means with a corresponding set of selection data in a previous version recorded in the recording means on a module-by-module basis so as to detect a module of which substance is common among the two sets of selection data, and
(3) replacing means for replacing the substance of the module detected by the detecting means with an instruction command that instructs the plurality of data receiving apparatuses to use the module in the previous version.

15. The data transmitting apparatus according to claim 11, wherein
the organizing means further includes information data appending means for appending information data relating to each corresponding set of the selection data to each piece of the unique data extracted by the unique data extracting means.

16. A data receiving apparatus for receiving and storing a set of control program data targeted for the data receiving apparatus selectively from among a plurality of sets of control program data transmitted from a data transmitting apparatus to a plurality of data receiving apparatuses, wherein
each set of the control program data has been divided into a plurality of modules and transmitted sequentially,
the plurality of modules includes one or more unique modules that are the modules other than the modules being common among all the control program data, and
each of the unique modules is appended with a piece of module information that is used to determine whether the module is executable and is to be stored by each data receiving apparatus,
the data receiving apparatus comprising:
recording means for recording, in advance, specific information for specifying a unique module that is executable and is to be stored by the data receiving apparatus;
obtaining means for obtaining module information appended to each of the unique modules;
determining means for determining whether each of the unique modules is executable and is to be stored by the data receiving apparatus with reference to the module information and the specific information; and
storing means, when the determining means determines that each of the modules is executable and is to be stored by the data receiving apparatus, for receiving the module and for storing the module being executable in a predetermined device.

17. The data receiving apparatus according to claim 16, wherein
each of the unique modules has been encrypted to be decryptable with a specific decryption key,
each piece of the module information includes identification information relating to the specific decryption key corresponding to the unique modules,
the specific information includes
(1) the specific decryption key used to decrypt each of the unique modules that is executable and is to be stored by the data receiving apparatus, and
(2) identification information relating to the specific decryption key,
the determining means determines that each of the unique modules is executable and is to be stored by the data receiving apparatus when the module information includes identification information that matches the identification information included in the specific information, and
the storing means, when the determining means determines that each of the module is executable and is to be stored by the data receiving apparatus, receives the module, decrypts the module with the corresponding decryption key included in the identification information, and stores the module being executable in the predetermined device.

18. The data receiving apparatus according to claim 17, wherein
the storing means, when the determining means does not determine that each of the modules is executable and is to be stored by the data receiving apparatus, further receives the module and stores the non-decrypted and thus non-executable module in the predetermined device.

19. The data receiving apparatus according to claim 18, further comprising:
decryption key acquiring means for externally acquiring a decryption key that is not recorded in the recording means to record the newly acquired decryption key in the recording means;
detecting means for detecting, if any module is stored without decrypting and thus being non-executable, a module that is decryptable with the newly acquired decryption key; and
decrypting means for decrypting the module detected by the detecting means and storing the decrypted module being executable in the predetermined device.

20. The data receiving apparatus according to claim 16, wherein
the storing means
when the determining means determines that each of the modules is executable and is to be stored by the data receiving apparatus, receives and temporarily stores the module, and
when the determining means does not determine that each of the modules is executable and is to be stored by the data receiving apparatus, and when there is any module temporarily stored, stores the temporarily stored module in the predetermined device in a manner to overwrite a corresponding module stored therein during the time the module not to be stored is being transmitted.

21. The data receiving apparatus according to claim 20, wherein
each set of the control program data is (1) a set of data each targeted for a different data receiving apparatus model, (2) a set data targeted for the same data receiving apparatus model but in a different version, or (3) a set of data targeted for a different data receiving apparatus model and in a different version,
the module information includes information relating to a target data receiving apparatus model, a version of the unique module, or both a version and a target data receiving apparatus model,
the specific information includes its own data receiving apparatus model, a desired version of unique module, or both its own data receiving apparatus model and the desired version of unique module, and
the determining means determines that each of the unique modules is executable and is to be stored by the data receiving apparatus when the module information indicates that the module is targeted for the data receiving apparatus and a desired version.

22. The data receiving apparatus according to claim 21, wherein
the determining means includes
(1) version holding means for holding a version of each of the modules being executable and stored, in advance, in the predetermined device,
(2) model determining means for determining whether the module information indicates that the module is targeted for the data receiving apparatus, and
(3) version determining means for determining, when the model determining means determines that the module is targeted for the data receiving apparatus, whether a version indicated by the module information is newer than the version held by the holding means and for designating, when the module is determined to be a newer version, the version as the desired version.

23. The data receiving apparatus according to claim 21, further comprising:
presenting means for presenting to a user information relating to a currently available version for rewrite and
accepting means for accepting a desired version designation from the user based on the presented information by the presenting means,
and wherein the determining means includes
(1) model determining means for determining whether the module information indicates that the module is targeted for the data receiving apparatus, and
(2) version determining means for determining, when the model determining means determines that the module is targeted for the data receiving apparatus, whether a version indicated by the module information matches the desired version accepted by the accepting means to designate the version determined to match the accepted desired version as the desired version.

24. The data receiving apparatus according to claim 21, wherein,
the module information includes charge information, appended to each module or to each piece of module information, that indicates whether a charge is to be made for the module, and
the storing means includes
(1) charge determining means for determining whether a charge is to be made for each of the modules with reference to the charge information appended to the module or to the module information when the determining means determines the module is executable and is to be stored by the data receiving apparatus, and
(2) charging means for performing charging processing on each of the modules when the charge determining means determines that a charge is to be made.

25. The data receiving apparatus according to claim 21, wherein
the storing means includes
(1) instruction command determining means for determining whether a substance of each of the modules is an instruction command that instructs the data receiving apparatus to use a previous version module when the determining means determines that the module is executable and is to be stored by the data receiving apparatus, and
(2) copying means for assuming a previous version module that is stored, in advance, in the predetermined device and that corresponds to the module determined by the instruction command determining means to be the instruction command is overwritten with the desired version without changing the substance of the previous version module.

26. The data receiving apparatus according to claim 21, wherein
at least one of the unique modules is appended with information data relating to the control program data that includes the unique module or relating to the unique module, and
the storing means includes
information presenting means for presenting, if any information is attached to each of the modules, the information to the user during or after receiving the module, or during or after storing the module when the determining means determines that the module is executable and is to be stored by the data receiving apparatus.

27. A data transmitting program for use by a data transmitting apparatus that transmits data to a plurality of data receiving apparatuses, the data transmitting program makes the data receiving apparatus perform:
an acquiring step for acquiring a plurality of sets selection data, each set of which is targeted for one data receiving apparatus model;
an organizing step for comparing the plurality of sets of selection data and extracting common data and unique data, the common data being a portion of one set of selection data that is also contained in one or more other sets of selection data and the unique data being a remaining portion in each set of selection data left after excluding the common data; and
a transmitting step for transmitting the common data and the unique data together to the plurality of data receiving apparatuses.

28. The data transmitting program according to claim 27, wherein
each set of the selection data acquired in the acquiring step is composed of a plurality of modules,
recording means included in the data transmitting apparatus records, in advance, an encryption key that corresponds to each of the module extracted as the unique data extracted in the organizing step,
the organizing step includes
(1) a common data extracting substep for extracting, as the common data, a module of which substance is common among all the sets of selection data by comparing the plurality of sets of selection data module by module,
(2) a unique data extracting substep for extracting, as the unique data, all the modules other than the modules extracted in the common data extracting substep, and
(3) an encrypting substep for encrypting each of the modules extracted as the unique data using the corresponding encryption key recorded in the recording means, and
the transmitting step transmits the modules extracted as the common data in the common data extracting substep and the modules encrypted in the encrypting substep together to the plurality of data receiving apparatuses.

29. The data transmitting program according to claim 27, wherein
the organizing step
extracts, as the common data, a portion of selection data that is common among two or more sets of selection data,
appends, to each piece of the extracted common data, all pieces of identification information relating to sets of the selection data from which the piece of the common data has been extracted, and
appends, to each piece of the extracted unique data, one piece of identification information relating to one set of the selection data from which the piece of the unique data has been extracted, and
the transmitting step transmits together
each piece of the common data together with all the pieces of identification information appended thereto, and
each piece of the unique data together with the one piece of identification information appended thereto.

30. A data receiving program for use by a data receiving apparatus that receives and stores a set of control program data targeted for the data receiving apparatus selectively from among a plurality of sets of control program data transmitted from a data transmitting apparatus to a plurality of data receiving apparatuses, wherein
each set of the control program data has been divided into a plurality of modules and transmitted sequentially,
the plurality of modules includes one or more unique modules that are the modules other than the modules being common among all the control program data,
each of the unique modules is appended with a piece of module information that is used to determine whether the module is executable and is to be stored by each data receiving apparatus, and
recording means included in the data receiving apparatus records, in advance, specific information for specifying a unique module that is executable and is to be stored by the data receiving apparatus,
the data receiving program makes the data receiving apparatus perform:
an obtaining step for obtaining module information appended to each of the unique modules;
a determining step for determining whether each of the unique module is executable and is to be stored by the data receiving apparatus with reference to the module information and the specific information; and
a storing step, when the determining step determines that each of the modules is executable and is to be stored by the data receiving apparatus, for receiving the module and for storing the module being executable in a predetermined device.

31. The data receiving program according to claim 30, wherein, in the data receiving program,
each of the unique modules has been encrypted to be decryptable with a specific decryption key,
each piece of the module information includes identification information relating to the specific decryption key corresponding to the unique modules,
the specific information includes
(1) the specific decryption key used to decrypt each of the unique modules that is executable and is to be stored by the data receiving apparatus, and
(2) identification information relating to the specific decryption key,
the determining step determines that each of the unique modules is executable and is to be stored by the data receiving apparatus when the module information includes identification information that matches the identification information included in the specific information, and
the storing step, when the determining step determines that each of the module is executable and is to be stored by the data receiving apparatus, receives the module, decrypts the module with the corresponding decryption key included in the identification information, and stores the module being executable in the predetermined device.

32. The data receiving program according to claim 30, wherein, in the data receiving program,
the storing steps
when the determining step determines that each of the module is executable and is to be stored by the data receiving apparatus, receives and temporarily stores the module, and
when the determining step does not determine that each of the modules is executable and is to be stored by the data receiving apparatus, and when there is any module temporarily stored, stores the temporarily stored module in the predetermined device in a manner to overwrite a corresponding module stored therein during the time the module not to be stored is being transmitted.

33. A computer-readable storage medium storing a data transmitting program for use by a data transmitting apparatus that transmits data to a plurality of data receiving apparatuses, the data transmitting program makes the data transmitting apparatus perform:
an acquiring step for acquiring a plurality of sets selection data, each set of which is targeted for one data receiving apparatus model;
an organizing step for comparing the plurality of sets of selection data and extracting common data and unique data, the common data being a portion of one set of selection data that is also contained in one or more other sets of selection data and the unique data being a remaining portion in each set of selection data left after excluding the common data; and
a transmitting step for collectively transmitting the common data and the unique data to the plurality of data receiving apparatuses.

34. The computer-readable storage medium according to claim 33, wherein in the data transmitting program,
each set of the selection data acquired in the acquiring step is composed of a plurality of modules,
recording means included in the data transmitting apparatus records, in advance, an encryption key that corresponds to each of the modules extracted as the unique data in the organizing step,
the organizing step includes
(1) a common data extracting substep for extracting, as the common data, a module of which substance is common among all the sets of selection data by comparing the plurality of sets of selection data module by module,
(2) a unique data extracting substep for extracting, as the unique data, all the modules other than the modules extracted in the common data extracting substep,
(3) an encrypting substep for encrypting each of the modules extracted as the unique data using the corresponding encryption key recorded in the recording means, and
the transmitting step transmits the modules extracted as the common data in the common data extracting substep together with the modules encrypted in the encrypting substep collectively to the plurality of data receiving apparatuses.

35. The computer-readable storage medium according to claim 33, wherein in the data transmitting program,
the organizing step
extracts, as the common data, a portion of selection data that is common among two or more sets of selection data,
appends, to each piece of the extracted common data, all pieces of identification information relating to sets of the selection data from which the piece of the common data has been extracted, and
appends, to each piece of the extracted unique data, one piece of identification information relating to one set of the selection data from which the piece of the unique data has been extracted, and
the transmitting step collectively transmits
each piece of the common data together with all the pieces of identification information appended thereto, and
each piece of the unique data together with the one piece of identification information appended thereto.

36. A computer-readable storage medium storing a data receiving program for use by a data receiving apparatus that receives and stores a set of control program data targeted for the data receiving apparatus selectively from among a plurality of sets of control program data transmitted from a data transmitting apparatus to a plurality of data receiving apparatuses, wherein
each set of the control program data has been divided into a plurality of modules and transmitted sequentially,
the plurality of modules includes one or more unique modules that are the modules other than the modules being common among all the control program data,
each of the unique modules is appended with a piece of module information that is used to determine whether the module is executable and is to be stored by each data receiving apparatus, and
recording means included in the data receiving apparatus records, in advance, specific information for specifying a unique module that is executable and is to be stored by the data receiving apparatus,
the data receiving program makes the data receiving apparatus perform;
an obtaining step for obtaining module information appended to each of the unique modules;
a determining step for determining whether each of the unique module is executable and is to be stored by the data receiving apparatus with reference to the module information and the specific information; and
a storing step, when the determining step determines that each of the modules is executable and is to be stored by the data receiving apparatus, for receiving the module and for storing the module being executable in a predetermined device.

37. The computer-readable storage medium according to claim 36, wherein in the data receiving program,
each of the unique modules has been encrypted to be decryptable with a specific decryption key,
each piece of the module information includes identification information relating to the specific decryption key corresponding to the unique modules,
the specific information includes
(1) the specific decryption key used to decrypt each of the unique modules that is executable and is to be stored by the data receiving apparatus, and
(2) identification information relating to the specific decryption key,
the determining step determines that each of the unique modules is executable and is to be stored by the data receiving apparatus when the module information includes identification information that matches the identification information included in the specific information, and
the storing step, when the determining step determines that each of the module is executable and is to be stored by the data receiving apparatus, receives the module, decrypts the module with the corresponding decryption key included in the identification information, and stores the module being executable in the predetermined device.

38. The computer-readable storage medium according to claim 36, wherein in the data receiving program,
the storing step
when the determining step determines that each of the module is executable and is to be stored by the data receiving apparatus, receives and temporarily stores the module, and
when the determining step does not determine that each of the modules is executable and is to be stored by the data receiving apparatus, and when there is any module temporarily stored, stores the temporarily stored module in the predetermined device in a manner to overwrite a corresponding module stored therein during the time the module not to be stored is being transmitted.
